(19) United States
(12) Patent Application Publication
(10) Pub. No.: US 2023/0025873 A1
(43) Pub. Date: Jan. 26, 2023

(54) METHOD AND APPARATUS FOR CONSISTENT LBT FAILURE DETECTION AND RECOVERY

(71) Applicant: FUJITSU LIMITED, Kawasaki-shi (JP)

(72) Inventors: Meiyi JIA, Beijing (CN); Lei ZHANG, Beijing (CN); Xin WANG, Beijing (CN)

(73) Assignee: FUJITSU LIMITED, Kawasaki-shi (JP)

(21) Appl. No.: 17/955,935

(22) Filed: Sep. 29, 2022

Related U.S. Application Data
(63) Continuation of application No. PCT/CN2020/084074, filed on Apr. 9, 2020.

(51) Int. Cl. H04W 76/19; H04W 74/08

(52) U.S. Cl. CPC H04W 76/19; H04W 74/0816; H04W 80/02

(57) ABSTRACT

A method and apparatus for consistent LBT failure detection and recovery. The method is applicable to a terminal equipment, and the method includes when a higher layer receives an LBT failure indication from lower layer(s) and a counter for consistent LBT failure detection is equal to a first value, or, when a higher layer receives an LBT failure indication from lower layer(s) and a counter for consistent LBT failure detection is greater than or equal to a first value and there exists no triggered consistent LBT failures in an active BWP in a serving cell of a terminal equipment, triggering the consistent LBT failures of the active BWP in the serving cell.

### CROSS-REFERENCE TO RELATED APPLICATION

This application is a continuation application of International Application PCT/CN2020/084074 filed on Apr. 9, 2020, and designated the U.S., the entire contents of which are incorporated herein by reference.

### TECHNICAL FIELD

This disclosure relates to the field of communication technologies.

### BACKGROUND

To provide 3GPP services on unlicensed frequency bands, the following mechanisms are introduced: Listen Before Talk (LBT) and discovery RS measurement timing configuration (DMTC). A lower layer performs an LBT procedure, and according to an LBT result, when it is determined that a channel is occupied, no transmission is performed. When the lower layer performs the LBT procedure before transmission and the transmission is not performed, that is, when uplink transmission is blocked due to an LBT failure, the lower layer indicates the LBT failure to an MAC layer.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In a New Radio (NR-U) system on an unlicensed frequency band, an LBT failure detection and recovery mechanism is introduced, which may also be referred to as a consistent LBT failure detection and recovery mechanism for uplink transmission. The LBT failure detection and recovery mechanism (also referred to as a consistent LBT failure detection and recovery mechanism for uplink transmission, an uplink LBT failure detection and recovery mechanism, a consistent LBT failure detection and recovery mechanism, or a consistent uplink LBT failure detection and recovery mechanism) may be an LBT failure detection procedure (consistent LBT failure detection procedure for uplink transmission), or an LBT failure recovery procedure (consistent LBT failure recovery procedure for uplink transmission), or a procedure including both an LBT failure detection procedure (consistent LBT failure detection procedure for uplink transmission) and an LBT failure recovery procedure (consistent LBT failure recovery procedure for uplink transmission).

A radio resource control (RRC) layer may configure a consistent LBT failure recovery procedure for a higher layer, such as MAC entity of an MAC layer. Consistent LBT failure is detected per uplink BWP (bandwidth part). For this purpose, a counter and a timer are introduced. When an uplink LBT failure occurs, the timer is started or restarted. Whenever the MAC layer receives an uplink LBT failure indication from lower layers (such as a physical layer), the counter is incremented by 1. When the received count value exceeds a predetermined value, consistent LBT failure has been triggered. Furthermore, when the timer expires, the counter is reset. The procedure may be deemed as “consistent (uplink) LBT failure detection procedure” or a part or a step of “consistent (uplink) LBT failure detection procedure”.

When consistent LBT failure occurs in a primary cell (PCell) or a primary secondary cell (PSCell), the terminal equipment may switch to another BWP and initiate random access. In this case, the terminal equipment triggers an MAC CE (control element) to indicate to the network the occurrence of consistent LBT failure, and the MAC CE is transmitted on a BWP to which the terminal equipment is switched during the random access procedure. The procedure may be deemed as “a recovery procedure of consistent (uplink) LBT failure (in a special cell)” or a part or a step of “a recovery procedure of consistent (uplink) LBT failure (in a special cell)”.

When consistent LBT failure is detected in a secondary cell (SCell), an MAC CE is used to report the failure to the network device to which the SCell belongs, and the MAC CE is transmitted on a cell other than the SCell where consistent LBT failure occurs. In addition, the MAC CE may report multiple failed cells.

When there exists no available uplink resource for transmitting the MAC CE indicating the SCell wherein the consistent LBT failure occurs, the terminal equipment may trigger a scheduling request (SR). When the terminal equipment successfully transmits the MAC CE indicating a LBT failure of a serving cell, consistent LBT failure is cancelled in the serving cell or the BWP. The procedure may be deemed as “a recovery procedure of consistent (uplink) LBT failure (in a secondary cell)” or a part or a step of “a recovery procedure of consistent (uplink) LBT failure (in a secondary cell)”.

According to existing rules, the MAC entity will: when consistent LBT failure has been triggered in the special cell (SpCell), i.e. the primary cell (PCell) or the primary secondary cell (PSCell), and the consistent LBT failure is not cancelled, and if uplink shared channel (UL-SCH) resources are available for a new transmission in the special cell and these UL-SCH resources can accommodate the LBT failure MAC CE plus its subheader as a result of logical channel prioritization (LCP), instruct a multiplexing and assembly procedure to generate the LBT failure MAC CE. Otherwise, when consistent LBT failure has been triggered in at least one secondary cell (SCell) and the consistent LBT failure is not cancelled, and if UL-SCH resources are available for a new transmission in a serving cell for which consistent LBT failure has not been triggered and these UL-SCH resources can accommodate the LBT failure MAC CE plus its subheader as a result of LCP, instruct a multiplexing and assembly procedure to generate the LBT failure MAC CE; otherwise, an SR for the LBT failure MAC CE has been triggered. This procedure may be deemed as “a recovery procedure of consistent (uplink) LBT failure” or a part or a step of “a recovery procedure of consistent (uplink) LBT failure”.

When a MAC PDU (protocol data unit) is transmitted and this PDU includes the LBT failure MAC CE, the MAC entity will cancel consistent LBT failure(s) triggered in a serving cell for which consistent LBT failure was indicated in the transmitted LBT failure MAC CE.

It was found by the inventors that for each activated serving cell configured with an LBT failure recovery configuration parameter lbt-FailureRecoveryConfig, MAC entity will: when an LBT failure indication is received from lower layers, start or restart a timer for consistent LBT failure detection lbt-FailureDetectionTimer, and increment a counter for consistent LBT failure detection LBT_COUNTER by 1; and when LBT_COUNTER≥lbt-FailureInstanceMaxCount, trigger consistent LBT failure for the active BWP in this serving cell. This procedure may be deemed as “a procedure of consistent (uplink) LBT failure detection” or a part or a step of “a procedure of consistent (uplink) LBT failure detection”.

For example, when the serving cell is a special cell (SpCell), when consistent LBT failure has been triggered in all uplink BWPs configured with physical random access channel (PRACH) occasion on same carrier in this serving cell, the consistent LBT failure is indicated to upper layers, such as an RRC layer; otherwise, when consistent LBT failure has not been triggered in all uplink BWPs configured with PRACH occasions on same carrier in this serving cell, any ongoing random access procedure in this serving cell is stopped, the active BWP is switched to an uplink BWP on same carrier in this serving cell configured with a PRACH occasion and for which consistent LBT failure has not been triggered, and a random access procedure is initiated. This procedure may be deemed as “a procedure of consistent (uplink) LBT failure recovery (in a special cell)” or a part or a step of “a procedure of consistent (uplink) LBT failure recovery (in a special cell)”.

In this way, for each activated serving cell configured with lbt-FailureRecoveryConfig, when LBT failure indication has been received from lower layers and LBT_COUNTER≥lbt-FailureInstanceMaxCount, the MAC entity will trigger the consistent LBT failure for the active BWP in the serving cell, and perform a series of actions. For example, when the (lbt-FailureInstanceMaxCount)-th LBT failure indication is received from the lower layers, the MAC entity will trigger consistent LBT failure; however, when it continues to receive LBT failure indications from the lower layers, as LBT_COUNTER continues to be incremented, the condition LBT_COUNTER≥lbt-FailureInstanceMaxCount is still satisfied, hence, it still continues to trigger consistent LBT failures and perform a series of actions.

Therefore, the terminal equipment may keep triggering consistent LBT failures and perform a series of actions, which are not actions expected the terminal equipment, and will increase power consumption of the terminal equipment and air interface overhead, such as random access resources and data transmission.

It was further found by the inventors that once the terminal equipment successfully transmits a MAC CE indicating consistent LBT failure in a serving cell, the consistent LBT failure(s) in the serving cell or BWP will be cancelled. In addition, in other cases, the terminal equipment can cancel a triggered consistent LBT failure as well.

For example, for a special cell (SpCell), upon MAC reset, if there exists consistent LBT failure triggered by a corresponding serving cell, the terminal equipment cancels consistent LBT failure; when BWP switching is performed on the corresponding serving cell due to that a BWP switching command or RRC signaling is received, the terminal equipment cancels triggered consistent LBT failure(s); and when consistent LBT failure recovery configuration (lbt-FailureRecoveryConfig IE) is reconfigured, triggered consistent LBT failure(s) are cancelled.

For the secondary cell (SCell), when the secondary cell is deactivated, the terminal equipment cancels all consistent LBT failures triggered by the secondary cell; when MAC is reset, if there exists consistent LBT failure triggered by a corresponding serving cell, the terminal equipment cancels the consistent LBT failure; when BWP switching is performed on the corresponding serving cell due to that a BWP switching command or RRC signaling is received, the terminal equipment cancels triggered consistent LBT failure(s); and if consistent LBT failure recovery configuration (lbt-FailureRecoveryConfig IE) is reconfigured, triggered consistent LBT failure(s) is cancelled.

When consistent LBT failure has been triggered, the terminal equipment will execute consistent LBT failure recovery procedure, such as BWP switching and/or transmitting an MAC CE, so as to inform the network device of consistent LBT failure in the terminal equipment. During this period, based on the rules above, consistent LBT failure triggering the recovery procedure may possibly be cancelled.

In the above-listed cases of cancelling triggered consistent LBT failure(s) by terminal equipment, for some situations, such as deactivation of a secondary cell, even if consistent LBT failure is cancelled, consistent LBT failure does exist, and continuing indicating consistent LBT failure to the network device will not bring an adverse consequence; however, for consistent LBT failure cancelled in other situations, a problem of indicated consistent LBT failure has been resolved, and when consistent LBT failure continues to be indicated to the network device, the network device may possibly misunderstand a busy situation of an NR-U channel, thereby resulting in unnecessary BWP switching and unnecessary SCell reconfiguration on the primary cell (PCell), and resulting in lower utilization efficiency of NR-U channels.

In order to solve one or more of the above problems, embodiments of this disclosure provide a method and apparatus for consistent LBT failure detection and recovery.

According to a first aspect of the embodiments of this disclosure, there is provided an apparatus for consistent LBT failure detection and recovery, applicable to a terminal equipment, the apparatus including: a first triggering unit configured to, when a higher layer receives an LBT failure indication from lower layer(s) and a counter for consistent LBT failure detection is equal to a first value, or when a higher layer receives an LBT failure indication from lower layer(s), a counter for consistent LBT failure detection is greater than or equal to a first value and there exists no triggered consistent LBT failure in an active BWP in a serving cell of the terminal equipment, trigger consistent LBT failure of the active BWP in the serving cell.

According to a second aspect of the embodiments of this disclosure, there is provided an apparatus for consistent LBT failure detection and recovery, applicable to a terminal equipment, the apparatus including: a first resetting unit configured to, when it satisfies a first condition, reset a counter for consistent LBT failure detection.

According to a third aspect of the embodiments of this disclosure, there is provided an apparatus for consistent LBT failure detection and recovery, applicable to a terminal equipment, the apparatus including at least one of the following units: a first indicating unit configured to, when consistent LBT failure is cancelled, indicate to generate information of consistent LBT failure; a second indicating unit configured to indicate cell information or frequency information of consistent LBT failure to a network device; and a first stopping unit configured to stop an ongoing consistent LBT failure recovery procedure.

According to a fourth aspect of the embodiments of this disclosure, there is provided an apparatus for consistent LBT failure detection and recovery, applicable to a network device, the apparatus including: a first receiving unit configured to receive first information of consistent LBT failure and/or second information of consistent LBT failure respectively from a terminal equipment; and/or, a second receiving unit configured to receive cell information or frequency information indicating consistent LBT failure from the terminal equipment.

According to a fifth aspect of the embodiments of this disclosure, there is provided a terminal equipment, including the apparatus as described in any one of the first to third aspects of the embodiments of this disclosure.

According to a sixth aspect of the embodiments of this disclosure, there is provided a network device, including the apparatus as described in the fourth aspect of the embodiments of this disclosure.

According to a seventh aspect of the embodiments of this disclosure, there is provided a communication system, including the terminal equipment as described in the fifth aspect of the embodiments of this disclosure and/or the network device as described in the sixth aspect of the embodiments of this disclosure.

According to an eighth aspect of the embodiments of this disclosure, there is provided a method for consistent LBT failure detection and recovery, applicable to a terminal equipment, the method including: when a higher layer receives an LBT failure indication from lower layer(s) and a counter for consistent LBT failure detection is equal to a first value, or when a higher layer receives an LBT failure indication from lower layer(s), a counter for consistent LBT failure detection is greater than or equal to a first value and there exists no triggered consistent LBT failure in an active BWP in a serving cell of the terminal equipment, triggering consistent LBT failure of the active BWP in the serving cell.

According to a ninth aspect of the embodiments of this disclosure, there is provided a method for consistent LBT failure detection and recovery, applicable to a terminal equipment, the method including: when a first condition is satisfied, resetting a counter for consistent LBT failure detection.

According to a tenth aspect of the embodiments of this disclosure, there is provided a method for consistent LBT failure detection and recovery, applicable to a terminal equipment, the method including at least one of the following steps: when consistent LBT failure is cancelled, indicating to generate information of consistent LBT failure; indicating cell information or frequency information of consistent LBT failure to a network device; or stopping an ongoing consistent LBT failure recovery procedure.

According to an eleventh aspect of the embodiments of this disclosure, there is provided a method for consistent LBT failure detection and recovery, applicable to a network device, the method including: receiving first information of consistent LBT failure and/or second information of consistent LBT failure respectively from a terminal equipment; and/or, receiving cell information or frequency information indicating consistent LBT failure from the terminal equipment.

According to a twelfth aspect of the embodiments of this disclosure, there is provided a computer readable program, which, when executed in an apparatus for consistent LBT failure detection and recovery or a terminal equipment, will cause the apparatus for consistent LBT failure detection and recovery or the terminal equipment to carry out the method for consistent LBT failure detection and recovery as described in the eighth or ninth or ten aspect of the embodiments of this disclosure.

According to a thirteenth aspect of the embodiments of this disclosure, there is provided a computer storage medium, including a computer readable program, which will cause an apparatus for consistent LBT failure detection and recovery or a terminal equipment to carry out the method for consistent LBT failure detection and recovery as described in the eighth or ninth or ten aspect of the embodiments of this disclosure.

According to a fourteenth aspect of the embodiments of this disclosure, there is provided a computer storage program, which, when executed in an apparatus for consistent LBT failure detection and recovery or a network device, will cause the apparatus for consistent LBT failure detection and recovery or the network device to carry out the method for consistent LBT failure detection and recovery as described in the eleventh aspect of the embodiments of this disclosure.

According to a fifteenth aspect of the embodiments of this disclosure, there is provided a computer storage medium, including a computer readable program, which will cause an apparatus for consistent LBT failure detection and recovery or a network device to carry out the method for consistent LBT failure detection and recovery as described in the eleventh aspect of the embodiments of this disclosure.

An advantage of the embodiments of this disclosure exists in that:

consistent LBT failure is triggered only when the counter is equal to a first value, or consistent LBT failure is triggered when the counter is greater than or equal to the first value and there exists no triggered consistent LBT failure in an active BWP in a serving cell; hence, the terminal equipment may be prevented from keeping triggering unnecessary consistent LBT failures and executing a series actions, thereby lowering power consumption and air interface overhead of the terminal equipment; and/or

when a condition is met, the counter used for consistent LBT failure detection is reset, so that the terminal equipment may also be prevented from keeping triggering unnecessary consistent LBT failures and performing a series of actions, thereby lowering power consumption and air interface overhead of the terminal equipment; and/or,

by at least one of the following steps: when consistent LBT failure is cancelled, indicating to generate information of consistent LBT failure; indicating cell information or frequency information of consistent LBT failure to a network device; or stopping an ongoing consistent LBT failure recovery procedure, unnecessary BWP switching and secondary cell reconfiguration initiated by the network device may be avoided, and effective use of NR-U channels may be ensured.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of an embodiment of this disclosure;

FIG. 2 is a schematic diagram of the method for consistent LBT failure detection and recovery of Embodiment 1 of this disclosure;

FIG. 3 is another schematic diagram of the method for consistent LBT failure detection and recovery of Embodiment 1 of this disclosure;

FIG. 4 is a further schematic diagram of the method for consistent LBT failure detection and recovery of Embodiment 1 of this disclosure;

FIG. 5 is a schematic diagram of the method for consistent LBT failure detection and recovery of Embodiment 2 of this disclosure;

FIG. 6 is a schematic diagram of the method for consistent LBT failure detection and recovery of Embodiment 3 of this disclosure;

FIG. 7 is another schematic diagram of the method for consistent LBT failure detection and recovery of Embodiment 3 of this disclosure;

FIG. 8 is a further schematic diagram of the method for consistent LBT failure detection and recovery of Embodiment 3 of this disclosure;

FIG. 9 is still another schematic diagram of the method for consistent LBT failure detection and recovery of Embodiment 3 of this disclosure;

FIG. 10 is yet another schematic diagram of the method for consistent LBT failure detection and recovery of Embodiment 3 of this disclosure;

FIG. 11 is a schematic diagram of the method for consistent LBT failure detection and recovery of Embodiment 4 of this disclosure;

FIG. 12 is a schematic diagram of the method for consistent LBT failure detection and recovery of Embodiment 5 of this disclosure;

FIG. 13 is another schematic diagram of the method for consistent LBT failure detection and recovery of Embodiment 5 of this disclosure;

FIG. 14 is a schematic diagram of the apparatus for consistent LBT failure detection and recovery of Embodiment 6 of this disclosure;

FIG. 15 is a schematic diagram of the apparatus for consistent LBT failure detection and recovery of Embodiment 7 of this disclosure; FIG. 16 is a schematic diagram of the apparatus for consistent LBT failure detection and recovery of Embodiment 8 of this disclosure;

FIG. 17 is a schematic diagram of the second indicating unit of Embodiment 8 of this disclosure;

FIG. 18 is a schematic diagram of the apparatus for consistent LBT failure detection and recovery of Embodiment 9 of this disclosure;

FIG. 19 is a block diagram of a systematic structure of the terminal equipment of Embodiment 10 of this disclosure;

FIG. 20 is a block diagram of a systematic structure of the network device of Embodiment 11 of this disclosure;

FIG. 21 is a schematic diagram of an existing format of an LBT failure MAC CE of one byte; and

FIG. 22 is a schematic diagram of an existing format of an LBT failure MAC CE of four bytes.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (genescalen), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be an MACro cell or a pico cell, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, an MAChine-type communication device, a lap-top, a cordless telephone, a smart cell phone, a smart watch, and a digital camera, etc.

For another example, in a scenario of the Internet of Things (IoT), etc., the user equipment may also be an MAChine or a device performing monitoring or measurement. For example, it may include but not limited to an MAChine-type communication (MTC) terminal, a vehicle mounted communication terminal, a device to device (D2D) terminal, and an MAChine to machine (M2M) terminal, etc.

In the embodiments of this disclosure, all of “when . . . ”, “in a case where . . . ”, “for a case where . . . ” and “if . . . ” denote one or some conditions or states, and furthermore, all of these expressions are interchangeable.

Scenarios of the embodiments of this disclosure shall be described below by way of examples; however, this disclosure is not limited thereto.

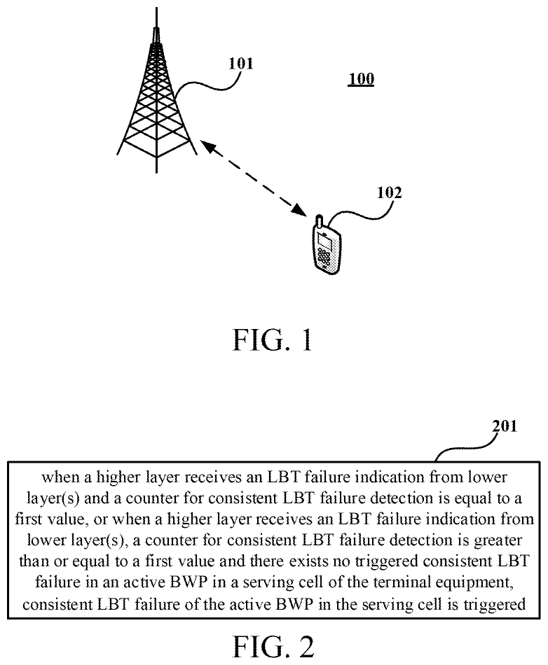

FIG. 1 is a schematic diagram of a communication system of an embodiment of this disclosure, in which a case where a terminal equipment and a network device are taken as examples is schematically shown. As shown in FIG. 1, a communication system 100 may include a network device 101 and a terminal equipment 102. For the sake of simplicity, an example having only one terminal equipment is schematically given in FIG. 1. The network device 101 is, for example, a network device gNB of NR.

In the embodiment of this disclosure, existing traffics or traffics that may be implemented in the future may be performed between the network device 101 and the terminal equipment 102. For example, such traffics may include but not limited to enhanced mobile broadband (eMBB), massive machine type communication (MTC), and ultra-reliable and low-latency communication (URLLC), etc.

LBT failure may occur when the terminal equipment 102 performs LBT. According to existing rules, when a higher layer of the terminal equipment 102 receives an LBT failure indication from lower layer(s) of the terminal equipment 102 and a condition LBT_COUNTER lbt-FailureInstanceMaxCount is satisfied, the higher layer of the terminal equipment 102 may continuously trigger consistent LBT failures and execute a series of actions, which are not intended by the terminal equipment 102, and will increase power consumption and air interface overhead of the terminal equipment, such as random access resources and data transmission.

In addition, according to existing rules, for some situations in which the terminal equipment 102 cancels triggered consistent LBT failure(s), the problem of the consistent LBT failure indicated by the terminal equipment 102 has been solved. When consistent LBT failure is continued to be indicated to the network device 101, the network device 101 may possibly misunderstand a busy situation of an NR-U channel, thereby resulting in unnecessary BWP switching and unnecessary SCell reconfiguration on the primary cell (PCell), and resulting in lower utilization efficiency of NR-U channels.

Various implementations of the embodiments of this disclosure shall be described below with reference to the accompanying drawings. These implementations are illustrative only, and are not intended to limit this disclosure.

### Embodiment 1

The embodiment of this disclosure provides a method for consistent LBT failure detection and recovery, applicable to a terminal equipment.

FIG. 2 is a schematic diagram of the method for consistent LBT failure detection and recovery of Embodiment 1 of this disclosure. As shown in FIG. 2, the method includes:

Step 201: when a higher layer receives an LBT failure indication from lower layer(s) and a counter for consistent LBT failure detection is equal to a first value, or when a higher layer receives an LBT failure indication from lower layer(s), a counter for consistent LBT failure detection is greater than or equal to a first value and there exists no triggered consistent LBT failure in an active BWP in a serving cell of the terminal equipment, consistent LBT failure of the active BWP in the serving cell is triggered.

Hence, the terminal equipment may be prevented from keeping triggering unnecessary consistent LBT failures and executing a series actions, thereby lowering power consumption and air interface overhead of the terminal equipment

In at least one embodiment of this disclosure, one of the lower layer(s) is, for example, a physical layer, and the higher layer is, for example, an MAC layer.

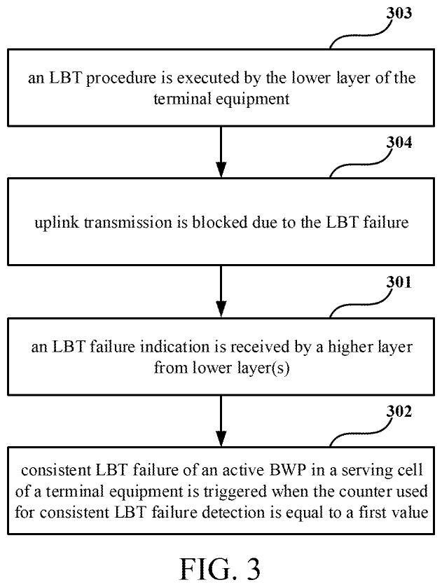

FIG. 3 is another schematic diagram of the method for consistent LBT failure detection and recovery of Embodiment 1 of this disclosure. As shown in FIG. 3, the method includes:

Step 301: an LBT failure indication is received by a higher layer from lower layer(s);

Step 302: consistent LBT failure of an active BWP in a serving cell of a terminal equipment is triggered when the counter used for consistent LBT failure detection is equal to a first value.

In step 301, the higher layer receives the LBT failure indication from the lower layer(s), that is, the lower layer(s) notify or indicate the LBT failure to the higher layer. And before step 301, the method may further include:

Step 303: an LBT procedure is executed by the lower layer(s) of the terminal equipment; and

Step 304: uplink transmission is blocked due to the LBT failure.

In this way, the uplink transmission is blocked due to the LBT failure, and the higher layer receives the LBT failure indication from the lower layer(s).

In step 302, when the count value of the counter for consistent LBT failure detection is equal to the first value, the consistent LBT failure of the active BWP in the serving cell of the terminal equipment is triggered.

In at least one embodiment of this disclosure, when an uplink LBT failure occurs, that is, when the higher layer has received the LBT failure indication from the lower layer(s), a timer, for example, lbt-FailureDetectionTimer, is started or restarted; and whenever the higher layer receives the LBT failure indication from the lower layer(s), the counter for consistent LBT failure detection is incremented by 1; when the counter is equal to the first value, the consistent LBT failure of the active BWP in the serving cell of the terminal equipment is triggered, and when the counter is greater than the first value, the consistent LBT failure of the active BWP in the serving cell of the terminal equipment is no longer triggered.

That is, after the consistent LBT failure of the BWP in the serving cell is triggered when the count value of the counter is equal to the first value, even if the higher layer continues to receive the LBT failure indication from the lower layer(s) and the count value of the counter continues to increase, it will not continue to trigger consistent LBT failure of the BWP in the serving cell, thereby preventing the terminal equipment from keeping triggering unnecessary consistent LBT failures and performing a series of actions.

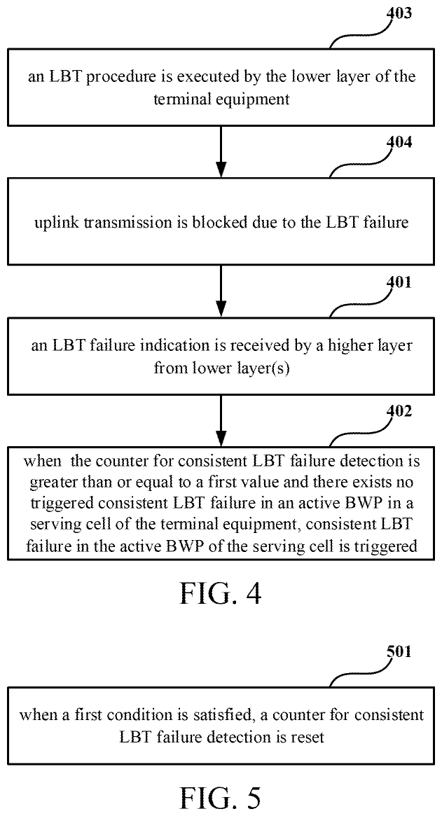

FIG. 4 is a further schematic diagram of the method for consistent LBT failure detection and recovery of Embodiment 1 of this disclosure. As shown in FIG. 4, the method includes:

Step 401: an LBT failure indication is received by a higher layer from lower layer(s); and

Step 402: when the counter for consistent LBT failure detection is greater than or equal to a first value and there exists no triggered consistent LBT failure in an active BWP in a serving cell of the terminal equipment, consistent LBT failure in the active BWP of the serving cell is triggered.

Similar to FIG. 3, before step 301, the method may further include:

Step 403: an LBT procedure is executed by the lower layer(s) of the terminal equipment; and

Step 404: uplink transmission is blocked due to the LBT failure.

In this way, the uplink transmission is blocked due to the LBT failure, and the higher layer receives the LBT failure indication from the lower layer(s).

In step 402, when the counter for consistent LBT failure detection is greater than or equal to the first value and there exists no triggered consistent LBT failure in an active BWP in a serving cell of the terminal equipment, consistent LBT failure in the active BWP of the serving cell is triggered.

In at least one embodiment of this disclosure, when an uplink LBT failure occurs, that is, when the higher layer has received the LBT failure indication from the lower layer(s), a timer, for example, lbt-FailureDetectionTimer, is started or restarted; and whenever the higher layer receives the LBT failure indication from the lower layer(s), the counter for consistent LBT failure detection is incremented by 1; when the counter reaches or exceeds the first value, whether there exists a triggered consistent LBT failure in an active BWP in a serving cell of the terminal equipment is determined, when there exists no triggered consistent LBT failure in the active BWP of the serving cell, consistent LBT failure in the active BWP of the serving cell is triggered, and when there exists a triggered consistent LBT failure in the active BWP of the serving cell, consistent LBT failure in the active BWP of the serving cell is not triggered. Hence, the terminal equipment may be prevented from keeping triggering unnecessary consistent LBT failures and performing a series of actions.

In at least one embodiment of this disclosure, for example, the counter for consistent LBT failure detection is LBT_COUNTER.

In at least one embodiment of this disclosure, the first value may be determined according to an actual situation, for example, the first value is denoted as lbt-FailurelnstanceMaxCount.

In at least one embodiment of this disclosure, the serving cell may be a special cell (SPCell), that is, a primary cell (PCell) or a primary secondary cell (PSCell), or, it may also be a secondary cell (SCell).

In at least one embodiment of this disclosure, for example, the series of actions are: for a special cell (SpCell), if consistent LBT failures have been triggered in all uplink BWPs on the same carrier in the serving cell configured with physical random access channel (PRACH) occasions, indicating consistent LBT failure to the higher layer; otherwise, stopping any ongoing random access procedure in the serving cell; switching the active BWP to an uplink BWP on the same carrier in the serving cell configured with a PRACH occasion in which consistent LBT failure has not been triggered; and initiating a random access procedure.

It can be seen from the above embodiment that consistent LBT failure is triggered only when the counter is equal to a first value, or consistent LBT failure is triggered when the counter is greater than or equal to the first value and there exists no triggered consistent LBT failure in an active BWP in a serving cell. Hence, the terminal equipment may be prevented from keeping triggering unnecessary consistent LBT failures and executing a series of actions, thereby lowering power consumption and air interface overhead of the terminal equipment.

### Embodiment 2

The embodiment of this disclosure provides a method for consistent LBT failure detection and recovery, applicable to a terminal equipment.

FIG. 5 is a schematic diagram of the method for consistent LBT failure detection and recovery of Embodiment 2 of this disclosure. As shown in FIG. 5, the method includes:

Step 501: when a first condition is satisfied, a counter for consistent LBT failure detection is reset.

In this way, when a condition is satisfied, the counter for consistent LBT failure detection is reset, thereby preventing the terminal equipment from keeping triggering unnecessary consistent LBT failures and performing a series of actions, and lowering power consumption and air interface overhead of the terminal equipment.

In at least one embodiment of this disclosure, the first condition may include at least one of the following conditions:

consistent LBT failure of an active BWP in a serving cell has been triggered, or there exists consistent LBT failure on an active BWP in a serving cell; or, consistent LBT failure of an active BWP in a serving cell has been triggered, or there exists consistent LBT failure on an active BWP in a serving cell;

an event causing triggered consistent LBT failure(s) to be cancelled occurs;

triggered consistent LBT failure(s) are cancelled;

an event causing instructing a multiplexing and assembly procedure to generate an LBT failure MAC CE occurs;

a multiplexing and assembly procedure is instructed to generate an LBT failure MAC CE;

an event causing a scheduling request (SR) for LBT failure MAC CE to be triggered occurs; or

a scheduling request (SR) of an LBT failure MAC CE has been triggered.

For example, the event causing triggered consistent LBT failure(s) to be cancelled includes at least one of the following that:

a BWP is deactivated;

a BWP is deactivated and is configured with consistent LBT failure recovery;

a BWP is deactivated and is configured with an LBT failure recovery configuration parameter, the LBT failure recovery configuration parameter being, for example, lbt-FailureRecoveryConfig;

a BWP is deactivated and is configured with the counter for consistent LBT failure detection, the counter being, for example, LBT_COUNTER;

information of LBT failure is transmitted, for example, an MAC PDU (protocol data unit) is transmitted and the PDU includes a consistent LBT failure MAC CE;

consistent LBT failure has been triggered and is not cancelled, and a random access procedure is considered successfully completed;

a secondary cell (SCell) is deactivated, or a message for deactivating a secondary cell is received, or a timer associated with a secondary cell expires; for example, the message for deactivating a secondary cell is carried by an SCell activation/deactivation MAC CE, and the time is, for example, sCellDeactivationTimer;

MAC entity receives a physical downlink control channel (PDCCH) for BWP switching of the serving cell, and there is no ongoing random access procedure associated with the serving cell or an ongoing random access procedure associated with the serving cell is successfully completed upon reception of physical downlink control channel addressed to cell radio network temporary identifier (C-RNTI); and

Upon reception of RRC configuration or RRC reconfiguration for BWP switching.

For example, the event causing instructing a multiplexing and assembly procedure to generate an LBT failure MAC CE includes at least one of the following events that:

consistent LBT failure has been triggered and not cancelled in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP); or

consistent LBT failure has been triggered and not cancelled in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP).

For example, the event causing a scheduling request for LBT failure MAC CE to be triggered includes: consistent LBT failure has been triggered and not cancelled in at least one secondary cell, and uplink shared channel (UL-SCH) resources are not available for a new transmission in a serving cell for which consistent LBT failure has not been triggered and these UL-SCH resources can accommodate the LBT failure MAC CE plus its sub-header as a result of logical channel prioritization (LCP).

In at least one embodiment of this disclosure, the first condition may occur in a special cell, or a secondary cell, or a serving cell.

In at least one embodiment of this disclosure, in step 501, reset a counter for consistent LBT failure detection includes: set the counter to 0. Therefore, it may also be said that the counter for consistent LBT failure detection is set to 0 when the first condition is satisfied.

In at least one embodiment of this disclosure, for example, the counter for consistent LBT failure detection is LBT_COUNTER.

In at least one embodiment of this disclosure, for example, the counter corresponds to a serving cell, a secondary cell, a special cell or an active BWP with consistent LBT failure indicated in the transmitted LBT failure MAC CE.

For another example, the counter corresponds to a serving cell, secondary cell, special cell or active BWP where triggered consistent LBT failure is located.

It can be seen from the above embodiment that the counter for consistent LBT failure detection is reset when a condition is satisfied. Hence, the terminal equipment may be prevented from keeping triggering unnecessary consistent LBT failures and executing a series of actions, thereby lowering power consumption and air interface overhead of the terminal equipment.

### Embodiment 3

The embodiment of this disclosure provides a method for consistent LBT failure detection and recovery, applicable to a terminal equipment.

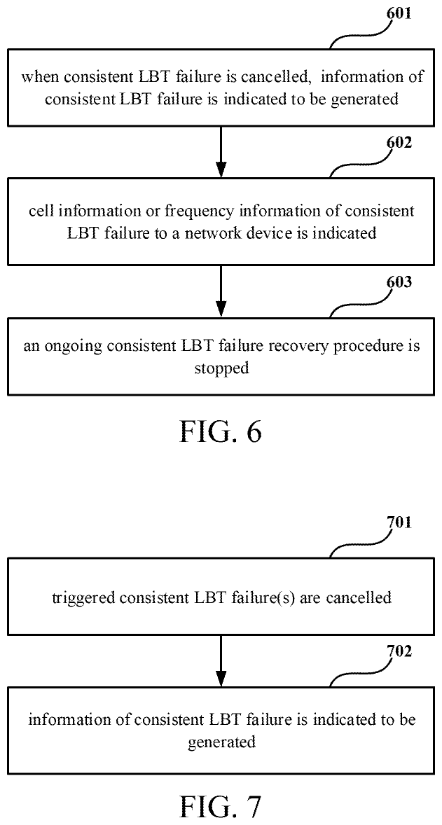

FIG. 6 is a schematic diagram of the method for consistent LBT failure detection and recovery of Embodiment 3 of this disclosure. As shown in FIG. 6, the method includes:

Step 601: when consistent LBT failure is cancelled, information of consistent LBT failure is indicated to be generated;

Step 602: cell information or frequency information of consistent LBT failure to a network device is indicated; and

Step 603: an ongoing consistent LBT failure recovery procedure is stopped.

In this way, unnecessary BWP switching and secondary cell reconfiguration initiated by network equipment may be avoided, and effective utilization of NR-U channels may be ensured.

In the embodiment of this disclosure, the method may include at least one of steps 601-603, and when the method includes two or three of the steps, an order of executing these steps is not limited.

Each of steps 601-603 shall be described below respectively.

In step 601, when consistent LBT failure is cancelled, it is indicated to generate the information of consistent LBT failure. In this way, the terminal equipment indicates updated information of consistent LBT failure to the network device, thereby avoiding unnecessary BWP switching and secondary cell reconfiguration initiated by the network device, and ensuring effective utilization of NR-U channels.

In at least one embodiment of this disclosure, the indicating to generate the information of consistent LBT failure may be indicating to generate the information of consistent LBT failure by a multiplexing and assembly entity, or MAC or RRC.

In at least one embodiment of this disclosure, the cancelling the consistent LBT failure may be caused by at least one of the following events: MAC reconfiguration; upon reception of an indication of BWP switching in a serving cell with triggered consistent LBT failure, such as receiving BWP switching DCI in the serving cell where consistent LBT failure has been triggered or receiving RRC signaling on the serving cell where consistent LBT failure has been triggered; and reconfiguration of consistent LBT failure recovery, such as an lbt-FailureRecoveryConfig IE.

In at least one embodiment of this disclosure, the LBT failure information indicated to be generated in step 601 may be carried by an MAC CE or a higher layer message.

In the embodiment of this disclosure, the MAC CE may be a second LBT failure MAC CE. For example, the second LBT failure MAC CE may reuse a format of an existing LBT failure MAC CE.

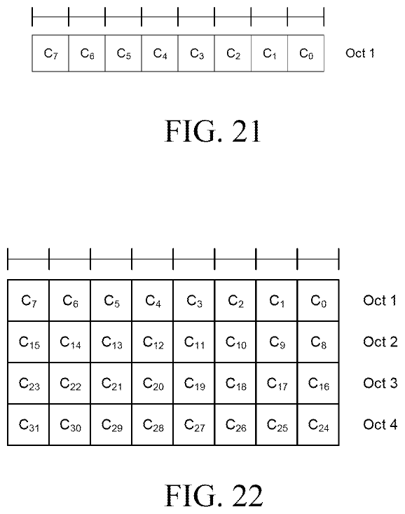

FIG. 21 is a schematic diagram of an existing format of an LBT failure MAC CE of one byte. As shown in FIG. 21, an LBT failure MAC CE of one byte is acknowledged by an MAC subheader carrying an LCID. Its size is fixed, including a single byte, that is, eight C fields. As to Cᵢ, when there exists a serving cell configuring a serving cell index i for MAC entity, and when consistent LBT failure has been triggered in this serving cell and is not cancelled, this field is set to be 1; otherwise this field is set to be 0.

FIG. 22 is a schematic diagram of an existing format of an LBT failure MAC CE of four bytes. As shown in FIG. 22, an LBT failure MAC CE of four bytes is acknowledged by an MAC subheader carrying an LCD. Its size is fixed, including four bytes, that is, 832 C fields. As to Cᵢ, when there exists a serving cell configuring a serving cell index i for MAC entity, and when consistent LBT failure has been triggered in this serving cell and is not cancelled, this field is set to be 1; otherwise this field is set to be 0.

In the embodiment of this disclosure, the MAC CE may be a second LBT failure MAC CE, or may be a new MAC CE, such as an LBT failure cancel MAC CE.

In the embodiment of this disclosure, the higher layer message is, for example, an RRC message.

Corresponding to step 601, FIG. 7 is another schematic diagram of the method for consistent LBT failure detection and recovery of Embodiment 3 of this disclosure. As shown in FIG. 7, the method includes:

Step 701: triggered consistent LBT failure(s) are cancelled; and

Step 702: information of consistent LBT failure is indicated to be generated.

In step 602, the terminal equipment indicates the cell information or frequency information of consistent LBT failure to the network device. In this way, the network device is made aware of the cell or frequency where consistent LBT failure occurs, thereby avoiding unnecessary BWP switching and secondary cell reconfiguration initiated by the network device, and ensuring effective utilization of NR-U channels.

In at least one embodiment of this disclosure, indicating the cell information or frequency information of the consistent LBT failure by the terminal equipment to the network device may be performed before the consistent LBT failure is cancelled, or may be performed at the time when consistent LBT failure is cancelled.

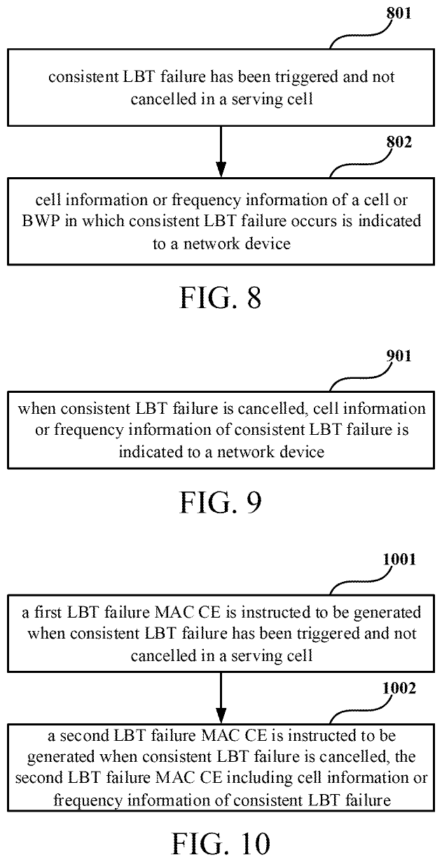

FIG. 8 is a further schematic diagram of the method for consistent LBT failure detection and recovery of Embodiment 3 of this disclosure. As shown in FIG. 8, the method includes:

Step 801: consistent LBT failure has been triggered and not cancelled in a serving cell;

Step 802: cell information or frequency information of a cell or BWP in which consistent LBT failure occurs is indicated to a network device.

In this way, before the consistent LBT failure is cancelled, the terminal equipment indicates the cell information or frequency information of the consistent LBT failure to the network device.

In step 801, it may be that a first LBT failure MAC CE is transmitted to the network device, and the cell information or frequency information of the cell or BWP in which consistent LBT failure occurs is carried by a first LBT failure MAC CE. That is, consistent LBT failure has been triggered in the serving cell and it is instructed that the first LBT failure MAC CE is generated, and the MAC CE further includes cell information or frequency information of the cell or BWP in which consistent LBT failure occurs.

In at least one embodiment of this disclosure, the information of the cell of consistent LBT failure indicates a cell where consistent LBT failure has been triggered and has not been cancelled, that is, in addition to the above cell, other cells where consistent LBT failures are triggered and are not been cancelled.

In at least one embodiment of this disclosure, that the consistent LBT failure has been triggered and not cancelled in a serving cell includes: consistent LBT failure has been triggered and not cancelled in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP); and/or consistent LBT failure has been triggered and not cancelled in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP).

In at least one embodiment of this disclosure, the frequency information of consistent LBT failure indicates a frequency of occurrence of consistent LBT failures.

FIG. 9 is still another schematic diagram of the method for consistent LBT failure detection and recovery of Embodiment 3 of this disclosure. As shown in FIG. 9, the method includes:

Step 901: when consistent LBT failure is cancelled, cell information or frequency information of consistent LBT failure is indicated to a network device.

In this way, when consistent LBT failure is cancelled, the terminal equipment indicates the cell information or frequency information of the consistent LBT failure to the network device.

In at least one embodiment of this disclosure, when consistent LBT failure is cancelled, the cell information or frequency information of consistent LBT failure indicated by the terminal equipment to the network device may be carried by an MAC CE or a higher layer message.

For the case of carrying by an MAC CE, for example, the MAC CE is a second LBT failure MAC CE. For example, the second LBT failure MAC CE may reuse a format of an existing LBT failure MAC CE.

Or, the MAC CE may be a new MAC CE, such as an LBT failure cancel MAC CE.

For the case of carrying by a higher layer message, for example, the higher layer message is an RRC message.

For the case of carrying by the MAC CE, FIG. 10 is yet another schematic diagram of the method for consistent LBT failure detection and recovery of Embodiment 3 of this disclosure. As shown in FIG. 10, the method includes:

Step 1001: a first LBT failure MAC CE is instructed to be generated when consistent LBT failure has been triggered and not cancelled in a serving cell; and

Step 1002: a second LBT failure MAC CE is instructed to be generated when consistent LBT failure is cancelled, the second LBT failure MAC CE including cell information or frequency information of consistent LBT failure.

In at least one embodiment of this disclosure, that the consistent LBT failure is cancelled is caused by at least one of the following events: MAC reconfiguration; upon reception of an indication of BWP switching in a serving cell with triggered consistent LBT failure, such as receiving BWP switching DCI in the serving cell where consistent LBT failure has been triggered or receiving RRC signaling on the serving cell where consistent LBT failure has been triggered; or reconfiguration of consistent LBT failure recovery, such as an lbt-FailureRecoveryConfig IE.

In step 603, the ongoing LBT failure recovery procedure is stopped.

In this way, the terminal equipment will not indicate to the network device for multiple times the consistent LBT failure that occurs on a certain serving cell, thereby avoiding unnecessary BWP switching and secondary cell reconfiguration initiated by the network device, and ensuring effective utilization of NR-U channels. In addition, unnecessary connection reestablishment may be avoided, and service interruption may also be avoided.

In at least one embodiment of this disclosure, the stopping the ongoing consistent LBT failure recovery procedure includes: stopping or suspending the ongoing consistent LBT failure recovery procedure.

That is, the stopping in the embodiment of this disclosure may refer to stop or suspension.

In at least one embodiment of this disclosure, in step 603, when consistent LBT failure is cancelled, the ongoing consistent LBT failure recovery procedure is stopped.

In at least one embodiment of this disclosure, that the consistent LBT failure is cancelled is caused by at least one of the following events: MAC reconfiguration; upon reception of an indication of BWP switching in a serving cell with triggered consistent LBT failure, such as receiving BWP switching DCI in the serving cell where consistent LBT failure has been triggered or receiving RRC signaling on the serving cell where consistent LBT failure has been triggered; and reconfiguration of consistent LBT failure recovery, such as an lbt-FailureRecoveryConfig IE.

In at least one embodiment of this disclosure, the stopping an ongoing consistent LBT failure recovery procedure includes at least one of the following behaviors:

stopping ongoing uplink transmission; clearing a hybrid automatic repeat request (HARQ) buffer of a corresponding HARQ procedure; stopping a random access procedure being performed on an active BWP in a BWP switching procedure triggered by the consistent LBT failure; stopping an ongoing RRC connection re-establishment procedure after a radio link failure (RLF) of a primary cell group (MCG) triggered by the consistent LBT failure; stopping an ongoing secondary cell group (SCG) failure information procedure after a radio link failure of an SCG triggered by the consistent LBT failure; and stopping ongoing random access procedure initiated by a pending scheduling request (SR) failed due to a radio link failure.

Steps 601-603 are described respectively above; however, the method in the embodiment of this disclosure may also be various combinations of steps 601-603.

It can be seen from the above embodiment that when consistent LBT failure is cancelled, it is indicated to generate information of consistent LBT failure; cell information or frequency information of consistent LBT failure is indicated to a network device; and an ongoing consistent LBT failure procedure is stopped. With at least one of the above steps, unnecessary BWP switching and secondary cell reconfiguration initiated by the network device may be avoided, and effective utilization of NR-U channels may be ensured.

### Embodiment 4

The embodiment of this disclosure provides a method for consistent LBT failure detection and recovery. This method is applicable to a network device, and corresponds to the method for consistent LBT failure detection and recovery applicable to a terminal equipment described in Embodiment 3, with identical contents being not going to be described herein any further.

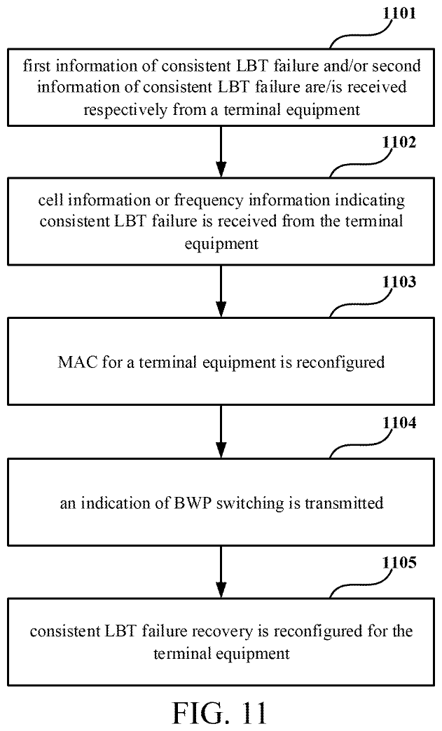

FIG. 11 is a schematic diagram of the method for consistent LBT failure detection and recovery of Embodiment 4 of this disclosure. As shown in FIG. 11, the method includes:

Step 1101: first information of consistent LBT failure and/or second information of consistent LBT failure are/is received respectively from a terminal equipment; and/or,

Step 1102: cell information or frequency information indicating consistent LBT failure is received from the terminal equipment.

In the embodiment of this disclosure, the method may include at least one of steps 1101 or 1102, and when the method includes both steps 1101 and 1102, an order of execution of these steps is not limited.

In this way, the network device obtains updated information of consistent LBT failure from the terminal equipment, and/or the network device may learn the cell or frequency where consistent LBT failure occurs, thereby avoiding unnecessary BWP switching and secondary cell reconfiguration initiated by the network device, and ensuring efficient utilization of NR-U channels.

In at least one embodiment of this disclosure, in step 1101, the first information of consistent LBT failure may be carried by the first LBT failure MAC CE, and the second information of consistent LBT failure may be carried by the second LBT failure MAC CE.

For example, when the first LBT failure MAC CE triggers consistent LBT failure in a serving cell and the consistent LBT failure is not cancelled, the terminal equipment instructs to generate the first LBT failure MAC CE and transmit to the network device, and when the second LBT failure MAC CE is cancelled when consistent LBT failure occurs, the terminal equipment instructs to generate the second LBT failure MAC CE and transmit to the network device.

In at least one embodiment of this disclosure, in step 1102, the cell information or frequency information of the consistent LBT failure is carried by a consistent LBT failure MAC CE or another MAC CE or higher layer message.

For example, the consistent LBT failure MAC CE is the first LBT failure MAC CE or the second LBT failure MAC CE.

For example, the higher layer message is an RRC message.

For example, before consistent LBT failure is cancelled, the terminal equipment indicates the cell information or frequency information of consistent LBT failure to the network device, or, when consistent LBT failure is cancelled, the terminal equipment indicates the cell information or frequency information of consistent LBT failure to the network device.

In at least one embodiment of this disclosure, as shown in FIG. 11, the method further includes at least one of the following steps:

Step 1103: MAC for a terminal equipment is reconfigured;

Step 1104: an indication of BWP switching is transmitted; and

Step 1105: consistent LBT failure recovery is reconfigured for the terminal equipment.

In the embodiment of this disclosure, the method may include at least one of steps 1103-1105, and when the method includes two or three of the steps, an order of execution of these steps is not limited. In addition, an order of execution of steps 1103-1105 and steps 1101 and 1102 is not limited.

In this way, with at least one of steps 1103-1105, consistent LBT failure triggering the terminal equipment is cancelled.

It can be seen from the above embodiment that the network device obtains updated information of consistent LBT failure from the terminal equipment, and/or the network device may learn the cell or frequency where the consistent LBT failure occurs, thereby avoiding unnecessary BWP switching and secondary cell reconfiguration initiated by the network device, and ensuring effective utilization of NR-U channels.

### Embodiment 5

The embodiment of this disclosure provides a method for consistent LBT failure detection and recovery. This method is applicable to a network device and a terminal equipment, and corresponds to the method for consistent LBT failure detection and recovery applicable to a terminal equipment described in Embodiment 3 and the method for consistent LBT failure detection and recovery applicable to a network device described in Embodiment 4, with identical contents being not going to be described herein any further.

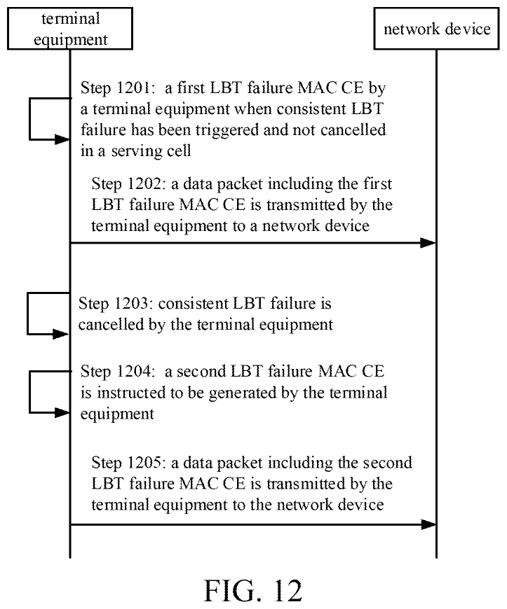

FIG. 12 is a schematic diagram of the method for consistent LBT failure detection and recovery of Embodiment 5 of this disclosure. As shown in FIG. 12, the method includes:

Step 1201: a first LBT failure MAC CE by a terminal equipment when consistent LBT failure has been triggered and not cancelled in a serving cell;

Step 1202: a data packet including the first LBT failure MAC CE is transmitted by the terminal equipment to a network device;

Step 1203: consistent LBT failure is cancelled by the terminal equipment;

Step 1204: a second LBT failure MAC CE is instructed to be generated by the terminal equipment; and

Step 1205: a data packet including the second LBT failure MAC CE is transmitted by the terminal equipment to the network device.

In at least one embodiment of this disclosure, the second LBT failure MAC CE may include updated information of consistent LBT failure.

In at least one embodiment of this disclosure, the second LBT failure MAC CE may include cell information or frequency information of the consistent LBT failure.

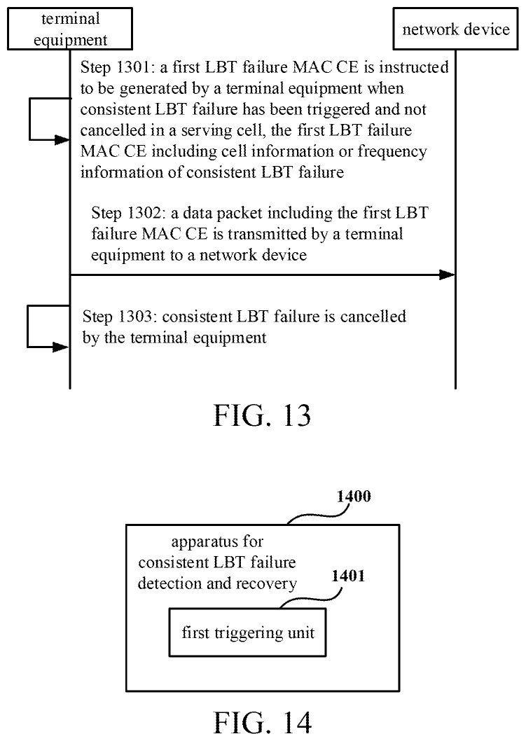

FIG. 13 is another schematic diagram of the method for consistent LBT failure detection and recovery of Embodiment 5 of this disclosure. As shown in FIG. 13, the method includes:

Step 1301: a first LBT failure MAC CE is instructed to be generated by a terminal equipment when consistent LBT failure has been triggered and not cancelled in a serving cell, the first LBT failure MAC CE including cell information or frequency information of consistent LBT failure;

Step 1302: a data packet including the first LBT failure MAC CE is transmitted by a terminal equipment to a network device; and

Step 1303: consistent LBT failure is cancelled by the terminal equipment.

In at least one embodiment of this disclosure, reference may be made to the description in Embodiment 3 and Embodiment 4 for particular implementations of the steps in FIG. 12 and FIG. 13, which shall not be described herein any further.

It can be seen from the above embodiment that the network device obtains updated information of consistent LBT failure from the terminal equipment, and/or the network device may learn the cell or frequency where consistent LBT failure occurs, thereby avoiding unnecessary BWP switching and secondary cell reconfiguration initiated by the network device, and ensuring effective utilization of NR-U channels.

### Embodiment 6

The embodiment of this disclosure provides an apparatus for consistent LBT failure detection and recovery, applicable to a terminal equipment. As a principle of the apparatus for solving problems is similar to that of the method of Embodiment 1, reference may be made to the implementations of the method of Embodiment 1 for implementations of this apparatus, with identical or related parts being not going to be described herein any further.

FIG. 14 is a schematic diagram of the apparatus for consistent LBT failure detection and recovery of Embodiment 6 of this disclosure. As shown in FIG. 14, an apparatus 1400 includes:

a first triggering unit 1401 configured to, when a higher layer receives an LBT failure indication from lower layer(s) and a counter for consistent LBT failure detection is equal to a first value, or when a higher layer receives an LBT failure indication from lower layer(s), a counter for consistent LBT failure detection is greater than or equal to a first value and there exists no triggered consistent LBT failure in an active BWP in a serving cell of the terminal equipment, trigger consistent LBT failure of the active BWP in the serving cell.

In at least one embodiment of this disclosure, the terminal equipment and/or the serving cell is/are configured with an LBT failure recovery configuration parameter.

In at least one embodiment of this disclosure, the LBT failure recovery configuration parameter is a parameter lbt-FailureRecoveryConfig, or a parameter lbt-FailureInstanceMaxCount and/or a parameter lbt-FailureDetectionTimer.

In this embodiment, reference may be made to the contents of the relevant steps in Embodiment 1 for implementations of functions of the above unit, which shall not be described herein any further.

It can be seen from the above embodiment that consistent LBT failure is triggered only when the counter is equal to a first value, or consistent LBT failure is triggered when the counter is greater than or equal to the first value and there exists no triggered consistent LBT failure in an active BWP in a serving cell. Hence, the terminal equipment may be prevented from keeping triggering unnecessary consistent LBT failures and executing a series of actions, thereby lowering power consumption and air interface overhead of the terminal equipment.

### Embodiment 7

The embodiment of this disclosure provides an apparatus for consistent LBT failure detection and recovery, applicable to a terminal equipment. As a principle of the apparatus for solving problems is similar to that of the method of Embodiment 2, reference may be made to the implementations of the method of Embodiment 2 for implementations of this apparatus, with identical or related parts being not going to be described herein any further.

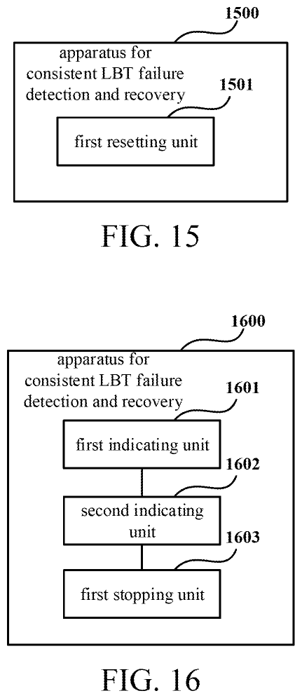

FIG. 15 is a schematic diagram of the apparatus for consistent LBT failure detection and recovery of Embodiment 7 of this disclosure. As shown in FIG. 15, an apparatus 1500 includes:

a first resetting unit 1501 configured to, when a first condition is satisfied, reset a counter for consistent LBT failure detection.

In at least one embodiment of this disclosure, the first condition includes at least one of the following conditions: consistent LBT failure of an active BWP in a serving cell has been triggered, or there exists consistent LBT failure on an active BWP in a serving cell; an event causing triggered consistent LBT failure(s) to be cancelled occurs; triggered consistent LBT failure(s) are cancelled; an event causing instructing a multiplexing and assembly procedure to generate an LBT failure MAC CE occurs; a multiplexing and assembly procedure is instructed to generate an LBT failure MAC CE; an event causing a scheduling request for LBT failure MAC CE to be triggered occurs; or a scheduling request for LBT failure MAC CE has been triggered.

In at least one embodiment of this disclosure, the event causing triggered consistent LBT failure(s) to be cancelled includes at least one of the following that: a BWP is deactivated; a BWP is deactivated and is configured with consistent LBT failure recovery; a BWP is deactivated and is configured with an LBT failure recovery configuration parameter; a BWP is deactivated and is configured with the counter for consistent LBT failure detection; information of LBT failure is transmitted; consistent LBT failure has been triggered and is not cancelled, and a random access procedure is considered successfully completed; a secondary cell is deactivated, or a message for deactivating a secondary cell is received, or a timer associated with a secondary cell expires; MAC entity receives a physical downlink control channel (PDCCH) for BWP switching of the serving cell, and there is no ongoing random access procedure associated with the serving cell or an ongoing random access procedure associated with the serving cell is successfully completed upon reception of physical downlink control channel addressed to cell radio network temporary identifier (C-RNTI); and upon reception of RRC configuration or RRC reconfiguration for BWP switching.

In at least one embodiment of this disclosure, the event causing instructing a multiplexing and assembly procedure to generate an LBT failure MAC CE includes at least one of the following events that: consistent LBT failure has been triggered and not cancelled in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP); and consistent LBT failure has been triggered and not cancelled in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP).

In at least one embodiment of this disclosure, the event causing a scheduling request for LBT failure MAC CE to be triggered includes: consistent LBT failure has been triggered and not cancelled in at least one secondary cell, and uplink shared channel (UL-SCH) resources are not available for a new transmission in a serving cell for which consistent LBT failure has not been triggered and these UL-SCH resources can accommodate the LBT failure MAC CE plus its sub-header as a result of logical channel prioritization (LCP).

In at least one embodiment of this disclosure, the first condition occurs in a special cell, or a secondary cell, or a serving cell.

In at least one embodiment of this disclosure, reset a counter for consistent LBT failure detection includes: set the counter to 0.

In at least one embodiment of this disclosure, the counter corresponds to a serving cell, or a secondary cell, or a special cell or an active BWP of consistent LBT failure indicated by a transmitted LBT failure MAC CE.

In at least one embodiment of this disclosure, the counter corresponds to a serving cell, or a secondary cell, or a special cell or an active BWP where a triggered consistent LBT failure is located.

It can be seen from the above embodiment that the counter for consistent LBT failure detection is reset when a condition is satisfied. Hence, the terminal equipment may be prevented from keeping triggering unnecessary consistent LBT failures and executing a series of actions, thereby lowering power consumption and air interface overhead of the terminal equipment.

### Embodiment 8

The embodiment of this disclosure provides an apparatus for consistent LBT failure detection and recovery, applicable to a terminal equipment. As a principle of the apparatus for solving problems is similar to that of the method of Embodiment 3, reference may be made to the implementations of the method of Embodiment 3 for implementations of this apparatus, with identical or related parts being not going to be described herein any further.

FIG. 16 is a schematic diagram of the apparatus for consistent LBT failure detection and recovery of Embodiment 8 of this disclosure. As shown in FIG. 16, an apparatus 1600 includes at least one of the following units:

a first indicating unit 1601 configured to, when consistent LBT failure is cancelled, indicate to generate information of consistent LBT failure;

a second indicating unit 1602 configured to indicate cell information or frequency information of consistent LBT failure to a network device; or

a first stopping unit 1603 configured to stop an ongoing consistent LBT failure recovery procedure.

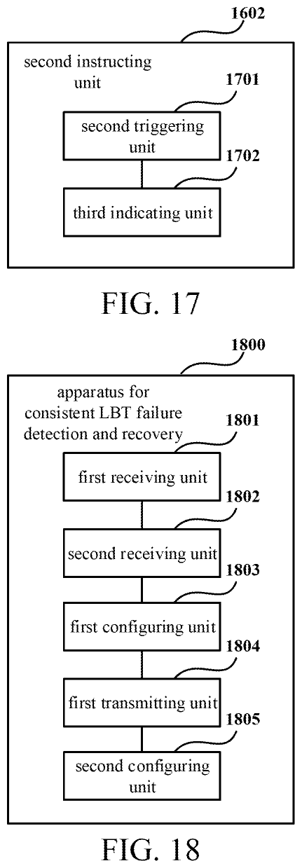

FIG. 17 is a schematic diagram of the second indicating unit of Embodiment 8 of this disclosure. As shown in FIG. 17, the second indicating unit 1602 includes:

a second triggering unit 1701 configured to trigger and not cancel consistent LBT failure in a serving cell;

a third indicating unit 1702 configured to indicate cell information or frequency information of consistent LBT failure to the network device.

In at least one embodiment of this disclosure, the third indicating unit 1702 transmits a first LBT failure MAC CE to the network device, and the cell information or frequency information of the cell or BWP in which the consistent LBT failure occurs is carried by the first LBT failure MAC CE.

In at least one embodiment of this disclosure, the second triggering unit 1701 triggers and does not cancel consistent LBT failure in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP); and/or triggers and does not cancel consistent LBT failure in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP).

In at least one embodiment of this disclosure, when consistent LBT failure is cancelled, the third indicating unit 1702 indicates to the network device the cell information or frequency information of the cell or BWP in which consistent LBT failure occurs.

In at least one embodiment of this disclosure, when consistent LBT failure is cancelled, the cell information or frequency information of the consistent LBT failure indicated to the network device is carried by an MAC CE or a higher layer message.

In at least one embodiment of this disclosure, when consistent LBT failure is cancelled, the generated information of consistent LBT failure is indicated to be carried by a second LBT failure MAC CE.

In at least one embodiment of this disclosure, that the consistent LBT failure is cancelled is caused by at least one of the following events: MAC reconfiguration; upon reception of an indication of BWP switching in a serving cell with triggered consistent LBT failure; or reconfiguration of consistent LBT failure recovery.

In at least one embodiment of this disclosure, the first stopping unit 1603 stops or suspends the ongoing consistent LBT failure recovery procedure.

In at least one embodiment of this disclosure, the first stopping unit 1603 stops the ongoing consistent LBT failure recovery procedure when consistent LBT failure is cancelled.

In at least one embodiment of this disclosure, that the consistent LBT failure is cancelled is caused by at least one of the following events: MAC reconfiguration; upon reception of an indication of BWP switching in a serving cell with triggered consistent LBT failure; and reconfiguration of consistent LBT failure recovery.

In at least one embodiment of this disclosure, the stopping an ongoing consistent LBT failure recovery procedure comprises at least one of the following behaviors: stopping ongoing uplink transmission; clearing a hybrid automatic repeat request (HARQ) buffer of a corresponding HARQ procedure; stopping a random access procedure being performed on an active BWP in a BWP switching procedure triggered by consistent LBT failure; stopping an ongoing RRC connection re-establishment procedure after a radio link failure (RLF) of a primary cell group (MCG) triggered by consistent LBT failure; stopping an ongoing secondary cell group (SCG) failure information procedure after a radio link failure of an SCG triggered by consistent LBT failure; or stopping ongoing random access procedure initiated by a pending scheduling request (SR) failed due to a radio link failure.

It can be seen from the above embodiment that when consistent LBT failure is cancelled, it is indicated to generate information of consistent LBT failure; the cell information or frequency information of the consistent LBT failure is indicated to the network device; and the ongoing consistent LBT failure procedure is stopped. With at least one of the above steps, unnecessary BWP switching and secondary cell reconfiguration initiated by the network device may be avoided, and effective utilization of NR-U channels may be ensured.

### Embodiment 9

The embodiment of this disclosure provides an apparatus for consistent LBT failure detection and recovery, applicable to a network device. As a principle of the apparatus for solving problems is similar to that of the method of Embodiment 4, reference may be made to the implementations of the method of Embodiment 4 for implementations of this apparatus, with identical or related parts being not going to be described herein any further.

FIG. 18 is a schematic diagram of the apparatus for consistent LBT failure detection and recovery of Embodiment 9 of this disclosure. As shown in FIG. 18, an apparatus 1800 includes: a first receiving unit 1801 configured to receive first information of consistent LBT failure and/or second information of consistent LBT failure respectively from a terminal equipment; and/or,

a second receiving unit 1802 configured to receive cell information or frequency information indicating consistent LBT failure from the terminal equipment.

In at least one embodiment of this disclosure, the first information of consistent LBT failure is carried by a first LBT failure MAC CE, and the second information of consistent LBT failure is carried by a second LBT failure MAC CE.

In at least one embodiment of this disclosure, the cell information or frequency information of the consistent LBT failure is carried by a consistent LBT failure MAC CE, another MAC CE or a higher layer message.

In at least one embodiment of this disclosure, the apparatus 1800 further includes at least one of the following units:

a first configuring unit 1803 configured to reconfigure MAC for the terminal equipment;

a first transmitting unit 1804 configured to transmit an indication of BWP switching; or

a second configuring unit 1805 configured to reconfigure consistent LBT failure recovery for the terminal equipment.

It can be seen from the above embodiment that the network device obtains updated information of consistent LBT failure from the terminal equipment, and/or the network device may learn the cell or frequency where consistent LBT failure occurs, thereby avoiding unnecessary BWP switching and secondary cell reconfiguration initiated by the network device, and ensuring effective utilization of NR-U channels.

### Embodiment 10

The embodiment of this disclosure provides a terminal equipment, including the apparatus for consistent LBT failure detection and recovery as described in Embodiment 6 or Embodiment 7 or Embodiment 8.

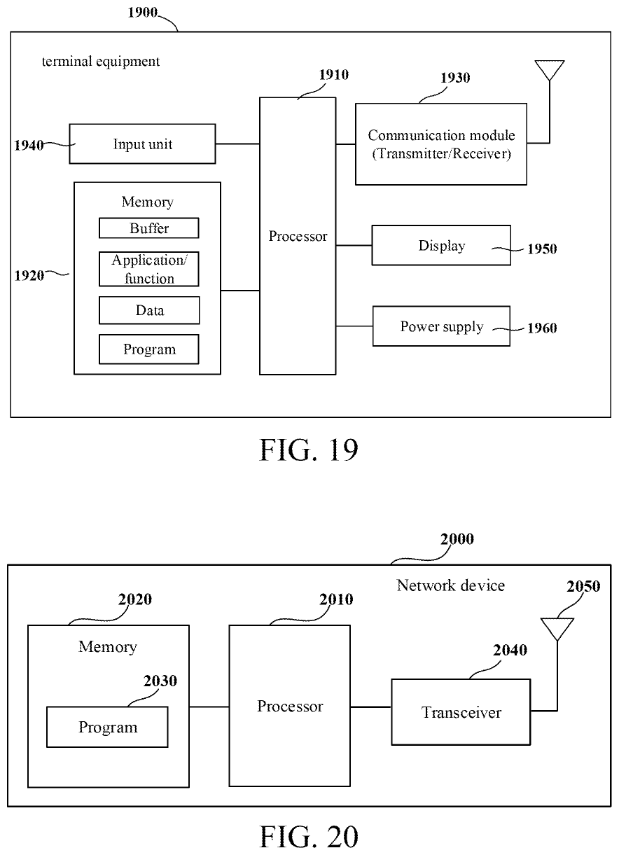

FIG. 19 is a block diagram of a systematic structure of the terminal equipment of Embodiment 10 of this disclosure. As shown in FIG. 19, a terminal equipment 1900 may include a processor 1910 and a memory 1920, the memory 1920 being coupled to the processor 1910. It should be noted that this figure is illustrative only, and other types of structures may also be used, so as to supplement or replace this structure and achieve a telecommunications function or other functions.

In one implementation, the functions of the apparatus for consistent LBT failure detection and recovery may be integrated into the processor 1910.

Corresponding to Embodiment 6, the processor 1910 may be configured to: when a higher layer receives an LBT failure indication from lower layer(s) and a counter for consistent LBT failure detection is equal to a first value, or when a higher layer receives an LBT failure indication from lower layer(s), a counter for consistent LBT failure detection is greater than or equal to a first value and there exists no triggered consistent LBT failure in an active BWP in a serving cell of the terminal equipment, trigger consistent LBT failure of the active BWP in the serving cell.

Corresponding to Embodiment 7, the processor 1910 may be configured to: when it satisfies a first condition, reset a counter for consistent LBT failure detection.

Corresponding to Embodiment 8, the processor 1910 may be configured to: when consistent LBT failure is cancelled, indicate to generate information of consistent LBT failure; indicate cell information or frequency information of consistent LBT failure to a network device; and stop an ongoing consistent LBT failure recovery process.

In another implementation, the apparatus for consistent LBT failure detection and recovery and the processor 1910 may be configured separately; for example, the apparatus for consistent LBT failure detection and recovery may be configured as a chip connected to the processor 1910, and the functions of the apparatus for consistent LBT failure detection and recovery are executed under control of the processor 1910.

As shown in FIG. 19, the terminal equipment 1900 may further include a communication module 1930, an input unit 1940, a display 1950 and a power supply 1960. It should be noted that the terminal equipment 1900 does not necessarily include all the parts shown in FIG. 19. Furthermore, the terminal equipment 1900 may include parts not shown in FIG. 19, and the related art may be referred to.

As shown in FIG. 19, the processor 1910 is sometimes referred to as a controller or an operational control, which may include a microprocessor or other processor devices and/or logic devices. The processor 1910 receives input and controls operations of components of the terminal equipment 1900.

In at least one embodiment of this disclosure, the memory 1920 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1910 may execute programs stored in the memory 1920, so as to realize information storage or processing, etc. Functions of other parts are similar to those of the related art, which shall not be described herein any further. The parts of the terminal equipment 1900 may be realized by specific hardware, firmware, software, or any combination thereof, without departing from the scope of this disclosure.

It can be seen from the above embodiment that consistent LBT failure is triggered only when the counter is equal to a first value, or consistent LBT failure is triggered when the counter is greater than or equal to the first value and there exists no triggered consistent LBT failure in an active BWP in a serving cell; hence, the terminal equipment may be prevented from keeping triggering unnecessary consistent LBT failures and executing a series actions, thereby lowering power consumption and air interface overhead of the terminal equipment; and/or, when a condition is met, the counter used for consistent LBT failure detection is reset, so that the terminal equipment may also be prevented from keeping triggering unnecessary consistent LBT failures and performing a series of actions, thereby lowering power consumption and air interface overhead of the terminal equipment; and/or, by at least one of the following steps: when consistent LBT failure is cancelled, indicating to generate information of consistent LBT failure; indicating cell information or frequency information of consistent LBT failure to a network device; and stopping an ongoing consistent LBT failure recovery procedure, unnecessary BWP switching and secondary cell reconfiguration initiated by the network device may be avoided, and effective use of NR-U channels may be ensured.

### Embodiment 11

The embodiment of this disclosure provides a network device, including the apparatus for consistent LBT failure detection and recovery described in Embodiment 9.

FIG. 20 is a schematic diagram of a systematic structure of the network device of Embodiment 11 of this disclosure. As shown in FIG. 20, a network device 2000 may include a processor 2010 and a memory 2020, the memory 2020 being coupled to the processor 2010. The memory 2020 may store various data, and furthermore, it may store a program 2030 for data processing, and execute the program 2030 under control of the processor 2010, so as to receive various information transmitted by a terminal equipment, and transmit various information to the terminal equipment.

In one implementation, the functions of the apparatus for consistent LBT failure detection and recovery may be integrated into the processor 2010. The processor 2010 may be configured to: receive first information of consistent LBT failure and/or second information of consistent LBT failure respectively from a terminal equipment; and/or, receive cell information or frequency information indicating consistent LBT failure from the terminal equipment.

For example, the first information of consistent LBT failure is carried by a first LBT failure MAC CE, and the second information of consistent LBT failure is carried by a second LBT failure MAC CE.

For example, the cell information or frequency information of consistent LBT failure is carried by an LBT failure MAC CE or another MAC CE or a higher layer message.

For example, the processor 2010 may further be configured to execute at least one of the following steps: reconfiguring MAC for the terminal equipment; transmitting an indication of BWP switching; and reconfiguring consistent LBT failure recovery for the terminal equipment. In another implementation, the apparatus for consistent LBT failure detection and recovery and the processor 2010 may be configured separately; for example, the apparatus for consistent LBT failure detection and recovery may be configured as a chip connected to the processor 2010, and the functions of the apparatus for consistent LBT failure detection and recovery are executed under control of the processor 2010.

Furthermore, as shown in FIG. 20, the network device 2000 may include a transceiver 2040, and an antenna 2050, etc. Functions of the above components are similar to those in the related art, and shall not be described herein any further. It should be noted that the network device 2000 does not necessarily include all the parts shown in FIG. 20. Furthermore, the network device 2000 may include parts not shown in FIG. 20, and the related art may be referred to.

It can be seen from the above embodiment that the network device obtains updated information of consistent LBT failure from the terminal equipment, and/or the network device may learn the cell or frequency where consistent LBT failure occurs, thereby avoiding unnecessary BWP switching and secondary cell reconfiguration initiated by the network device, and ensuring effective utilization of NR-U channels.

### Embodiment 12

The embodiment of this disclosure provides a communication system, including the terminal equipment described in Embodiment 10 and/or the network device described in Embodiment 11.

For example, reference may be made to FIG. 1 for a structure of the communication system. As shown in FIG. 1, the communication system 100 includes a network device 101 and a terminal equipment 102. The terminal equipment 102 is identical to the terminal equipment described in Embodiment 11, and the network device 101 is identical to the network device in Embodiment 12, with identical contents being not going to be described herein any further.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIGS. 14, 15 and 16 may either correspond to software modules of procedures of a computer program, or correspond to hardware modules. Such software modules may respectively correspond to the steps shown in FIGS. 2, 5 and 6. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIGS. 14, 15 and 16 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 18 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

According to the above implementations disclosed in the embodiments, following supplements are further disclosed.

Supplement I

1. An apparatus for consistent LBT failure detection and recovery, applicable to a terminal equipment, the apparatus including:

a first triggering unit configured to, when a higher layer receives an LBT failure indication from lower layer(s) and a counter for consistent LBT failure detection is equal to a first value, or when a higher layer receives an LBT failure indication from lower layer(s), a counter for consistent LBT failure detection is greater than or equal to a first value and there exists no triggered consistent LBT failure in an active BWP in a serving cell of the terminal equipment, trigger consistent LBT failure of the active BWP in the serving cell.

2. The apparatus according to supplement 1, wherein,

the terminal equipment and/or the serving cell is/are configured with an LBT failure recovery configuration parameter.

3. The apparatus according to supplement 2, wherein,

the LBT failure recovery configuration parameter is a parameter lbt-FailureRecoveryConfig.

4. An apparatus for consistent LBT failure detection and recovery, applicable to a terminal equipment, the apparatus including:

a first resetting unit configured to, when a first condition is satisfied, reset a counter for consistent LBT failure detection.

5. The apparatus according to supplement 4, wherein the first condition includes at least one of the following conditions:

consistent LBT failure of an active BWP in a serving cell has been triggered, or there exists consistent LBT failure on an active BWP in a serving cell;

an event causing triggered consistent LBT failure(s) to be cancelled occurs;

triggered consistent LBT failure(s) are cancelled;

an event causing instructing a multiplexing and assembly procedure to generate an LBT failure MAC CE occurs;

a multiplexing and assembly procedure is instructed to generate an LBT failure MAC CE;

an event causing a scheduling request for LBT failure MAC CE to be triggered occurs; or

a scheduling request for LBT failure MAC CE has been triggered.

6. The apparatus according to supplement 5, wherein the event causing triggered consistent LBT failure(s) to be cancelled includes at least one of the following that:

a BWP is deactivated;

a BWP is deactivated and is configured with consistent LBT failure recovery;

a BWP is deactivated and is configured with an LBT failure recovery configuration parameter;

a BWP is deactivated and is configured with the counter for consistent LBT failure detection;

information of LBT failure is transmitted;

consistent LBT failure has been triggered and is not cancelled, and a random access procedure is considered successfully completed;

a secondary cell is deactivated, or a message for deactivating a secondary cell is received, or a timer associated with a secondary cell expires;

MAC entity receives a physical downlink control channel (PDCCH) for BWP switching of the serving cell, and there is no ongoing random access procedure associated with the serving cell or an ongoing random access procedure associated with the serving cell is successfully completed upon reception of physical downlink control channel addressed to cell radio network temporary identifier (C-RNTI); and

upon reception of RRC configuration or RRC reconfiguration for BWP switching.

7. The apparatus according to supplement 5, wherein the event causing instructing a multiplexing and assembly procedure to generate an LBT failure MAC CE includes at least one of the following events that:

consistent LBT failure has been triggered and not cancelled in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP); or

consistent LBT failure has been triggered and not cancelled in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP).

8. The apparatus according to supplement 5, wherein the event causing a scheduling request for LBT failure MAC CE to be triggered includes:

consistent LBT failure has been triggered and not cancelled in at least one secondary cell, and uplink shared channel (UL-SCH) resources are not available for a new transmission in a serving cell for which consistent LBT failure has not been triggered and these UL-SCH resources can accommodate the LBT failure MAC CE plus its sub-header as a result of logical channel prioritization (LCP).

9. The apparatus according to any one of supplements 4-8, wherein,

the first condition occurs in a special cell, or a secondary cell, or a serving cell.

10. The apparatus according to any one of supplements 4-9, wherein reset a counter for consistent LBT failure detection includes: set the counter to 0.

11. The apparatus according to any one of supplements 4-10, wherein the counter corresponds to a serving cell, or a secondary cell, or a special cell or an active BWP of consistent LBT failure indicated by a transmitted LBT failure MAC CE.

12. The apparatus according to any one of supplements 4-10, wherein the counter corresponds to a serving cell, or a secondary cell, or a special cell or an active BWP where triggered consistent LBT failure is located.

13. The apparatus according to any one of supplements 1-12, wherein,

one of the lower layer(s) is a physical layer, and the higher layer is a media access control (MAC) layer.

14. An apparatus for consistent LBT failure detection and recovery, applicable to a terminal equipment,

the apparatus including at least one of the following units:

a first indicating unit configured to, when consistent LBT failure is cancelled, indicate to generate information of consistent LBT failure;

a second indicating unit configured to indicate cell information or frequency information of consistent LBT failure to a network device; or

a first stopping unit configured to stop an ongoing consistent LBT failure recovery procedure.

15. The apparatus according to supplement 14, wherein the second indicating unit includes:

a third indicating unit configured to indicate cell information or frequency information of consistent LBT failure to the network device when the consistent LBT failure has been triggered and not cancelled in a serving cell.

16. The apparatus according to supplement 15, wherein the third indicating unit transmits a first LBT failure MAC CE to the network device, the cell information or frequency information of the cell or BWP in which the consistent LBT failure occurs being carried by the first LBT failure MAC CE.

17. The apparatus according to supplement 16, wherein that the consistent LBT failure has been triggered and not cancelled in a serving cell includes:

consistent LBT failure has been triggered and not cancelled in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP)triggering consistent LBT failure; and/or

consistent LBT failure has been triggered and not cancelled in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP)triggering consistent LBT failure.

18. The apparatus according to supplement 14, wherein when consistent LBT failure is cancelled, the second indicating unit indicates the cell information or frequency information of consistent LBT failure to the network device.

19. The apparatus according to supplement 18, wherein,

when consistent LBT failure is cancelled, the cell information or frequency information of the consistent LBT failure indicated to the network device is carried by an MAC CE or a higher layer message.

20. The apparatus according to supplement 14, wherein,

when consistent LBT failure is cancelled, the indicated generated information of consistent LBT failure is carried by a second LBT failure MAC CE.

21. The apparatus according to supplement 14 or 20, wherein,

that the consistent LBT failure is cancelled is caused by at least one of the following events:

MAC reconfiguration;

upon reception of an indication of BWP switching in a serving cell with triggered consistent LBT failure; or

reconfiguration of consistent LBT failure recovery.

22. The apparatus according to supplement 14, wherein the first stopping unit stops or suspends the ongoing consistent LBT failure recovery procedure.

23. The apparatus according to supplement 14 or 22, wherein,

the first stopping unit stops the ongoing consistent LBT failure recovery procedure when consistent LBT failure is cancelled.

24. The apparatus according to supplement 23, wherein that the consistent LBT failure is cancelled is caused by at least one of the following events:

MAC reconfiguration;

upon reception of an indication of BWP switching in a serving cell with triggered consistent LBT failure; or

reconfiguration of consistent LBT failure recovery.

25. The apparatus according to supplement 14 or 23, wherein the stopping an ongoing consistent LBT failure recovery procedure includes at least one of the following behaviors:

stopping ongoing uplink transmission;

clearing a hybrid automatic repeat request (HARQ) buffer of a corresponding HARQ procedure;

stopping a random access procedure being performed on an active BWP in a BWP switching procedure triggered by the consistent LBT failure;

stopping an ongoing RRC connection re-establishment procedure after a radio link failure (RLF) of a primary cell group (MCG) triggered by the consistent LBT failure;

stopping an ongoing secondary cell group (SCG) failure information procedure after a radio link failure of an SCG triggered by the consistent LBT failure; and stopping ongoing random access procedure initiated by a pending scheduling request (pending SR) failed due to a radio link failure.

26. An apparatus for consistent LBT failure detection and recovery, applicable to a network device, the apparatus including:

a first receiving unit configured to receive first information of consistent LBT failure and/or second information of consistent LBT failure respectively from a terminal equipment; and/or,

a second receiving unit configured to receive cell information or frequency information indicating consistent LBT failure from the terminal equipment.

27. The apparatus according to supplement 26, wherein,

the first information of consistent LBT failure is carried by a first LBT failure MAC CE,

and the second information of consistent LBT failure is carried by a second LBT failure MAC CE.

28. The apparatus according to supplement 27, wherein,

the first LBT failure MAC CE is generated instructed by the terminal equipment and transmitted to the network device when consistent LBT failure has been triggered and not cancelled in a serving cell, and/or

the second LBT failure MAC CE is generated instructed by the terminal equipment and transmitted to the network device when consistent LBT failure is cancelled.

29. The apparatus according to supplement 26, wherein,

cell information or frequency information of consistent LBT failure is carried by a consistent LBT failure MAC CE or another MAC CE or a higher layer message.

30. The apparatus according to supplement 29, wherein,

the consistent LBT failure MAC CE is the first LBT failure MAC CE or the second LBT failure MAC CE.

31. The apparatus according to supplement 26, wherein the apparatus further includes at least one of the following units:

a first configuring unit configured to reconfigure MAC for the terminal equipment;

a first transmitting unit configured to transmit an indication of BWP switching; or

a second configuring unit configured to reconfigure consistent LBT failure recovery configuration for the terminal equipment.

32. A terminal equipment, including the apparatus as described in any one of supplements 1-25.

33. A network device, including the apparatus as described in any one of supplements 26-31.

34. A communication system, including the terminal equipment as described in supplement 32 and/or the network device as described in supplement 33.

Supplement II

1. A method for consistent LBT failure detection and recovery, applicable to a terminal equipment, the method including:

when a higher layer receives an LBT failure indication from lower layer(s) and a counter for consistent LBT failure detection is equal to a first value, or when a higher layer receives an LBT failure indication from lower layer(s), a counter for consistent LBT failure detection is greater than or equal to a first value and there exists no triggered consistent LBT failure in an active BWP in a serving cell of the terminal equipment,

triggering consistent LBT failure of the active BWP in the serving cell.

2. The method according to supplement 1, wherein,

the terminal equipment and/or the serving cell is/are configured with an LBT failure recovery configuration parameter.

3. The method according to supplement 2, wherein,

the LBT failure recovery configuration parameter is a parameter lbt-FailureRecoveryConfig.

4. A method for consistent LBT failure detection and recovery, applicable to a terminal equipment, the method including:

when a first condition is satisfied, resetting a counter for consistent LBT failure detection.

5. The method according to supplement 4, wherein the first condition includes at least one of the following conditions:

consistent LBT failure of an active BWP in a serving cell has been triggered, or there exists consistent LBT failure on an active BWP in a serving cell;

an event causing triggered consistent LBT failure(s) to be cancelled occurs;

triggered consistent LBT failure(s) are cancelled;

an event causing instructing a multiplexing and assembly procedure to generate an LBT failure MAC CE occurs;

a multiplexing and assembly procedure is instructed to generate an LBT failure MAC CE;

an event causing a scheduling request for LBT failure MAC CE to be triggered occurs; or

a scheduling request for LBT failure MAC CE has been triggered.

6. The method according to supplement 5, wherein the event causing triggered consistent LBT failure(s) to be cancelled includes at least one of the following that:

a BWP is deactivated;

a BWP is deactivated and is configured with consistent LBT failure recovery;

a BWP is deactivated and is configured with an LBT failure recovery configuration parameter;

a BWP is deactivated and is configured with a counter for consistent LBT failure detection;

information of LBT failure is transmitted;

consistent LBT failure has been triggered and is not cancelled, and a random access procedure is considered successfully completed;

a secondary cell is deactivated, or a message for deactivating a secondary cell is received, or a timer associated with a secondary cell expires;

MAC entity receives a physical downlink control channel (PDCCH) for BWP switching of the serving cell, and there is no ongoing random access procedure associated with the serving cell or an ongoing random access procedure associated with the serving cell is successfully completed upon reception of physical downlink control channel addressed to cell radio network temporary identifier (C-RNTI); and

upon reception of RRC configuration or RRC reconfiguration for BWP switching.

7. The method according to supplement 5, wherein the event causing instructing a multiplexing and assembly procedure to generate an LBT failure MAC CE includes at least one of the following events that:

consistent LBT failure has been triggered and not cancelled in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP); or

consistent LBT failure has been triggered and not cancelled in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP).

8. The method according to supplement 5, wherein the event causing a scheduling request for LBT failure MAC CE to be triggered includes:

consistent LBT failure has been triggered and not cancelled in at least one secondary cell, and uplink shared channel (UL-SCH) resources are not available for a new transmission in a serving cell for which consistent LBT failure has not been triggered and these UL-SCH resources can accommodate the LBT failure MAC CE plus its sub-header as a result of logical channel prioritization (LCP).

9. The method according to any one of supplements 4-8, wherein,

the first condition occurs in a special cell, or a secondary cell, or a serving cell.

10. The method according to any one of supplements 4-9, wherein reset a counter for consistent LBT failure detection includes: set the counter to 0.

11. The method according to any one of supplements 4-10, wherein the counter corresponds to a serving cell, or a secondary cell, or a special cell or an active BWP of consistent LBT failure indicated by a transmitted LBT failure MAC CE.

12. The method according to any one of supplements 4-10, wherein the counter corresponds to a serving cell, or a secondary cell, or a special cell or an active BWP where a triggered consistent LBT failure is located.

13. The method according to any one of supplements 1-12, wherein,

one of the lower layer(s) is a physical layer, and the higher layer is a media access control (MAC) layer.

14. A method for consistent LBT failure detection and recovery, applicable to a terminal equipment,

the method including at least one of the following steps:

when consistent LBT failure is cancelled, indicating to generate information of consistent LBT failure;

indicating cell information or frequency information of consistent LBT failure to a network device; or

stopping an ongoing consistent LBT failure recovery procedure.

15. The method according to supplement 14, wherein the indicating cell information or frequency information of consistent LBT failure to a network device includes:

when consistent LBT failure has been triggered and not cancelled in a serving cell,

indicating cell information or frequency information of consistent LBT failure to the network device.

16. The method according to supplement 15, wherein the indicating cell information or frequency information of consistent LBT failure to the network device when consistent LBT failure has been triggered and not cancelled in a serving cell includes:

transmitting a first LBT failure MAC CE to the network device when the consistent LBT failure has been triggered and not cancelled in a serving cell, the cell information or frequency information of the cell or BWP in which the consistent LBT failure occurs being carried by the first LBT failure MAC CE.

17. The method according to supplement 16, wherein that the consistent LBT failure has been triggered and not cancelled in a serving cell includes:

consistent LBT failure has been triggered and not cancelled in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP)triggering consistent LBT failure; and/or

consistent LBT failure has been triggered and not cancelled in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP)triggering consistent LBT failure.

18. The method according to supplement 14, wherein the indicating the cell information or frequency information of consistent LBT failure to the network device includes:

when consistent LBT failure is cancelled, indicating the cell information or frequency information of consistent LBT failure to the network device.

19. The method according to supplement 18, wherein,

when consistent LBT failure is cancelled, the cell information or frequency information of the consistent LBT failure indicated to the network device is carried by an MAC CE or a higher layer message.

20. The method according to supplement 14, wherein,

when consistent LBT failure is cancelled, the indicated generated information of consistent LBT failure is carried by a second LBT failure MAC CE.

21. The method according to supplement 14 or 20, wherein,

that the consistent LBT failure is cancelled is caused by at least one of the following events: MAC reconfiguration;

upon reception of an indication of BWP switching in a serving cell with triggered consistent LBT failure; or

reconfiguration of consistent LBT failure recovery.

22. The method according to supplement 14, wherein the stopping the ongoing consistent LBT failure recovery procedure includes:

stopping or suspending the ongoing consistent LBT failure recovery procedure.

23. The method according to supplement 14 or 22, wherein,

the ongoing consistent LBT failure recovery procedure is stopped when consistent LBT failure is cancelled.

24. The method according to supplement 23, wherein that the consistent LBT failure is cancelled is caused by at least one of the following events:

MAC reconfiguration;

upon reception of an indication of BWP switching in a serving cell with triggered consistent LBT failure; or

reconfiguration of consistent LBT failure recovery.

25. The method according to supplement 14 or 23, wherein the stopping an ongoing consistent LBT failure recovery procedure includes at least one of the following behaviors:

stopping ongoing uplink transmission;

clearing a hybrid automatic repeat request (HARQ) buffer of a corresponding HARQ procedure;

stopping a random access procedure being performed on an active BWP in a BWP switching procedure triggered by the consistent LBT failure;

stopping an ongoing RRC connection re-establishment procedure after a radio link failure (RLF) of a primary cell group (MCG) triggered by the consistent LBT failure;

stopping an ongoing secondary cell group (SCG) failure information procedure after a radio link failure of an SCG triggered by the consistent LBT failure; and

stopping ongoing random access procedure initiated by a pending scheduling request (SR) failed due to a radio link failure.

26. A method for consistent LBT failure detection and recovery, applicable to a network device, the method including:

receiving first information of consistent LBT failure and/or second information of consistent LBT failure respectively from a terminal equipment; and/or,

receiving cell information or frequency information indicating consistent LBT failure from the terminal equipment.

27. The method according to supplement 26, wherein,

the first information of consistent LBT failure is carried by a first LBT failure MAC CE,

and the second information of consistent LBT failure is carried by a second LBT failure MAC CE.

28. The method according to supplement 27, wherein,

the first LBT failure MAC CE is generated instructed by the terminal equipment and transmitted to the network device when consistent LBT failure has been triggered and not cancelled in a serving cell, and/or

the second LBT failure MAC CE is generated instructed by the terminal equipment and transmitted to the network device when consistent LBT failure is cancelled.

29. The method according to supplement 26, wherein,

cell information or frequency information of consistent LBT failure is carried by a consistent LBT failure MAC CE or another MAC CE or a higher layer message.

30. The method according to supplement 29, wherein,

the consistent LBT failure MAC CE is the first LBT failure MAC CE or the second LBT failure MAC CE.

31. The method according to supplement 26, wherein the method further includes at least one of the following steps:

reconfiguring MAC for the terminal equipment;

transmitting an indication of BWP switching; or

reconfiguring consistent LBT failure recovery configuration for the terminal equipment.

What is claimed is:

1. An apparatus for consistent LBT failure detection and recovery, applicable to a terminal equipment, the apparatus comprising:
a first resetting unit configured to, for an activated serving cell configured with lbt-FailureRecoveryConfig, when a first condition is satisfied, reset a counter for consistent LBT failure detection,
the first condition comprising at least one of the following conditions:
consistent LBT failure of an active BWP in a serving cell has been triggered, or there exists consistent LBT failure on an active BWP in a serving cell;
an event causing triggered consistent LBT failure(s) to be cancelled occurs;
triggered consistent LBT failure(s) are cancelled in the serving cell, wherein one of the consistent LBT failures is triggered for an active BWP in the serving cell when LBT failure indication is received from lower layers and the counter for consistent LBT failure detection is equal or greater than lbt-FailureInstanceMaxCount;
an event causing instructing a multiplexing and assembly procedure to generate an LBT failure MAC CE occurs;
a multiplexing and assembly procedure is instructed to generate an LBT failure MAC CE;
an event causing a scheduling request for LBT failure MAC CE to be triggered occurs; or
a scheduling request for LBT failure MAC CE has been triggered.

2. The apparatus according to claim 1, wherein the event causing triggered consistent LBT failure(s) to be cancelled comprises at least one of the following that:
a BWP is deactivated;
a BWP is deactivated and is configured with consistent LBT failure recovery;
a BWP is deactivated and is configured with an LBT failure recovery configuration parameter;
a BWP is deactivated and is configured with a counter for consistent LBT failure detection;
information of LBT failure is transmitted;
consistent LBT failure has been triggered and is not cancelled, and a random access procedure is considered successfully completed;
a secondary cell is deactivated, or a message for deactivating a secondary cell is received, or a timer associated with a secondary cell expires;
MAC entity receives a physical downlink control channel (PDCCH) for BWP switching of the serving cell, and there is no ongoing random access procedure associated with the serving cell or an ongoing random access procedure associated with the serving cell is successfully completed upon reception of physical downlink control channel addressed to cell radio network temporary identifier (C-RNTI); or
upon reception of RRC configuration or RRC reconfiguration for BWP switching.

3. The apparatus according to claim 1, wherein the event causing instructing a multiplexing and assembly procedure to generate an LBT failure MAC CE comprises at least one of the following events that:
consistent LBT failure has been triggered and not cancelled in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP); or
consistent LBT failure has been triggered and not cancelled in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP).

4. The apparatus according to claim 1, wherein the event causing a scheduling request for LBT failure MAC CE to be triggered comprises:
consistent LBT failure has been triggered and not cancelled in at least one secondary cell, and uplink shared channel (UL-SCH) resources are not available for a new transmission in a serving cell for which consistent LBT failure has not been triggered and these UL-SCH resources can accommodate the LBT failure MAC CE plus its sub-header as a result of logical channel prioritization (LCP).

5. The apparatus according to claim 1, wherein reset a counter for consistent LBT failure detection comprises: set the counter to 0.

6. The apparatus according to claim 1, wherein,
one of the lower layers of the terminal equipment is a physical layer.

7. An apparatus for consistent LBT failure detection and recovery, applicable to a terminal equipment,
the apparatus comprising at least one of the following units:
a first indicating unit configured to, when consistent LBT failure is cancelled, indicate to generate information of consistent LBT failure;
a second indicating unit configured to indicate cell information or frequency information of consistent LBT failure to a network device; or
a first stopping unit configured to stop an ongoing consistent LBT failure recovery procedure.

8. The apparatus according to claim 7, wherein the second indicating unit comprises:
a second triggering unit configured to trigger consistent LBT failure in a serving cell and not cancelled; and
a third indicating unit configured to indicate cell information or frequency information of consistent LBT failure to the network device.

9. The apparatus according to claim 8, wherein the second triggering unit,
consistent LBT failure has been triggered and not cancelled in a special cell (SpCell), and uplink shared channel (UL-SCH) resources are available for a new transmission in the special cell and these UL-SCH resources can accommodate the LBT failure MAC CE plus its sub-header as a result of logical channel prioritization (LCP); and/or
consistent LBT failure has been triggered and not cancelled in at least one secondary cell, and uplink shared channel (UL-SCH) resources are available for a new transmission in a serving cell for which consistent LBT failure has not been triggered and these UL-SCH resources can accommodate the LBT failure MAC CE plus its sub-header as a result of logical channel prioritization (LCP).

10. The apparatus according to claim 7, wherein when consistent LBT failure is cancelled, the second indicating unit indicates the cell information or frequency information of consistent LBT failure to the network device.

11. The apparatus according to claim 7, wherein,
when consistent LBT failure is cancelled, the indicated generated information of consistent LBT failure is carried by a second LBT failure MAC CE.

12. The apparatus according to claim 7, wherein,
that consistent LBT failure is cancelled is caused by at least one of the following events:
MAC reconfiguration;
upon reception of an indication of BWP switching in a serving cell with triggered consistent LBT failure; or
reconfiguration of consistent LBT failure recovery.

13. The apparatus according to claim 7, wherein the first stopping unit stops or suspends the ongoing consistent LBT failure recovery procedure.

14. The apparatus according to claim 7, wherein,
the first stopping unit stops the ongoing consistent LBT failure recovery procedure when consistent LBT failure is cancelled.

15. The apparatus according to claim 14, wherein that consistent LBT failure is cancelled is caused by at least one of the following events:
MAC reconfiguration;
upon reception of an indication of BWP switching in a serving cell with triggered consistent LBT failure; or
reconfiguration of consistent LBT failure recovery.

16. The apparatus according to claim 7, wherein the stopping an ongoing consistent LBT failure recovery procedure comprises at least one of the following behaviors:
stopping ongoing uplink transmission;
clearing a hybrid automatic repeat request (HARQ) buffer of a corresponding HARQ procedure;
stopping a random access procedure being performed on an active BWP in a BWP switching procedure triggered by consistent LBT failure;
stopping an ongoing RRC connection re-establishment procedure after a radio link failure (RLF) of a primary cell group (MCG) triggered by consistent LBT failure;
stopping an ongoing secondary cell group (SCG) failure information procedure after a radio link failure of an SCG triggered by consistent LBT failure; and
stopping ongoing random access procedure initiated by a pending scheduling request (pending SR) failed due to a radio link failure.

17. An apparatus for consistent LBT failure detection and recovery, applicable to a network device, the apparatus comprising:
a first receiving unit configured to receive first information of consistent LBT failure and/or second information of consistent LBT failure respectively from a terminal equipment; and/or,
a second receiving unit configured to receive cell information or frequency information indicating consistent LBT failure from the terminal equipment.

18. The apparatus according to claim 17, wherein,
the first information of consistent LBT failure is carried by a first LBT failure MAC CE,
and the second information of consistent LBT failure is carried by a second LBT failure MAC CE.

19. The apparatus according to claim 18, wherein,
the first LBT failure MAC CE is generated instructed by the terminal equipment and transmitted to the network device when consistent LBT failure has been triggered and not cancelled in a serving cell, and/or
the second LBT failure MAC CE is generated instructed by the terminal equipment and transmitted to the network device when consistent LBT failure is cancelled.

20. The apparatus according to claim 17, wherein,
cell information or frequency information of consistent LBT failure is carried by a consistent LBT failure MAC CE or another MAC CE or a higher layer message.
